(19) United States
(12) Patent Application Publication
(10) Pub. No.: US 2026/0264274 A1
(43) Pub. Date: Sep. 10, 2026

(54) OVERHEAD SUPPORT AND CHARGING SYSTEM FOR A HUMANOID ROBOT

(71) Applicant: Figure AI Inc., San Jose, CA (US)

(72) Inventors: Ryan Benyshek, San Jose, CA (US); Sydney Hardy, San Jose, CA (US); Brian Mick, San Jose, CA (US); Nivay Anandarajah, San Jose, CA (US); Katarina Rodak, San Jose, CA (US)

(21) Appl. No.: 19/552,233

(22) Filed: Feb. 27, 2026

Related U.S. Application Data
(60) Provisional application No. 63/767,281, filed on Mar. 5, 2025.
(60) Provisional application No. 63/839,474, filed on Jul. 7, 2025.
(60) Provisional application No. 63/839,479, filed on Jul. 7, 2025.
(60) Provisional application No. 63/850,760, filed on Jul. 25, 2025.
(60) Provisional application No. 63/875,074, filed on Sep. 3, 2025.
(60) Provisional application No. 63/874,723, filed on Sep. 3, 2025.
(60) Provisional application No. 63/875,558, filed on Sep. 4, 2025.

(51) Int. Cl. B25J 19/00; B25J 19/06

(52) U.S. Cl. CPC B25J 19/005; B25J 19/06

(57) ABSTRACT

An overhead support and charging system for a humanoid robot includes a base with a vertical arm supporting a horizontal cantilever arm, a tether extending from the base comprising at least one electrical conductor and at least one mechanically tensionable cable, a power electronics assembly configured to convert utility power into charging power, and a coupler for mechanically and electrically connecting the tether to a humanoid robot coupling assembly. The coupling assembly includes a pair of frame couplers attachable to an upper extent of the robot's torso and a pair of electrically insulated, hinged rigid braces configured to conduct electrical power. A harness with an integrated power bus secures the robot to the system. The humanoid robot includes a torso assembly housing a battery pack and power distribution unit with frame couplers electrically connected thereto. A retractable tether system provides both mechanical support and electrical charging connectivity through a unified coupler mechanism.

### CROSS REFERENCE TO RELATED APPLICATIONS

This application claims the benefit of and priority to U.S. Provisional Patent Application Nos. 63/767,281 filed Mar. 5, 2025, 63/839,474 filed Jul. 7, 2025, 63/839,479 filed Jul. 7, 2025, 63/850,760 filed on Jul. 25, 2025, 63/875,074 filed on Sep. 3, 2025, 63/874,723 filed on Sep. 3, 2025, and 63/875,558 filed on Sep. 4, 2025, each of which is hereby expressly incorporated by reference herein in its entirety.

### TECHNICAL FIELD

The present disclosure relates generally to the design, manufacturing, and utilization of an overhead support and charging system for a humanoid robot. More specifically, this disclosure pertains to an overhead support and charging system that is configured to selectively supply electrical power to the humanoid robot and to provide physical support for the humanoid robot.

### BACKGROUND

Humanoid robots are increasingly being developed to perform tasks in environments originally designed for humans, including factories, warehouses, retail spaces, and domestic settings. Their bipedal, human-proportioned form allows them to navigate spaces, manipulate objects, and use tools in ways that wheeled or quadruped robots cannot readily achieve. As these robots take on more demanding and sustained workloads, however, their reliance on onboard battery power presents significant operational constraints.

Conventional approaches to robot charging typically require the robot to leave its work area and travel to a dedicated charging station, where it must remain idle for the duration of the charging cycle. This interrupts ongoing tasks, reduces overall productivity, and may require human intervention to manage task handoffs or to ensure the robot reaches the charging station before its battery is fully depleted. In applications where continuous operation is important-such as extended manufacturing shifts, around-the-clock warehouse logistics, or prolonged testing and development sessions—these charging interruptions represent a substantial limitation. Furthermore, humanoid robots face unique challenges related to stability and fall prevention. Unlike stationary industrial arms or low-center-of-gravity mobile platforms, a humanoid robot must continuously expend energy to maintain an upright posture. If battery reserves become critically low, the robot's ability to power its leg actuators and balance controllers may be compromised, potentially resulting in a fall that can damage the robot itself as well as nearby people, equipment, or property. Existing tethering solutions, where employed, often attach to the robot's neck, head, or arms, which can restrict the robot's range of motion, interfere with task execution, and risk damaging delicate components such as sensors and displays in the event of a sudden load.

There is accordingly a need for systems that can supply supplemental electrical power to a humanoid robot while the robot remains on task, that can provide passive mechanical support to reduce energy expenditure and mitigate fall risk, and that can interface with the robot without impeding its functional range of motion or exposing vulnerable components to damage.

### SUMMARY

In one aspect, an overhead support and charging system for a humanoid robot is provided. The system comprises a base including a vertical arm supporting a horizontal cantilever arm. A tether extends from the base and includes at least one electrical conductor and at least one mechanically tensionable cable. A power electronics assembly is configured to convert utility power into charging power suitable for the humanoid robot, and a coupler at a distal end of the tether is configured to mechanically and electrically connect the tether to a humanoid robot coupling assembly. In certain embodiments, the horizontal cantilever arm includes a pulley at a distal end configured to guide the tether. A winch assembly may be provided and configured to extend, retract, and hold the tether at set extensile positions. The winch assembly may include a rotatable electrical interface configured to maintain electrical conductivity while the winch assembly rotates during operation of the tether. The power electronics assembly may comprise a shell configured as a mechanically protective and electrically insulating housing, electronic subsystems housed within the shell including power conversion electronics and a central computer, and a power cord extending from the power electronics assembly configured to receive power from a standard wall outlet. In further embodiments, the tether includes one or more communication conductors configured to provide a communication bus selected from CAT5/6/7 Ethernet, USB, I2C, CAN, or MODBUS for data transmission between the overhead support and charging system and the humanoid robot.

In another aspect, a humanoid robot coupling assembly for connecting a humanoid robot to an overhead support and charging system is provided. The coupling assembly comprises a pair of frame couplers configured to be coupled to an upper extent of a torso of the humanoid robot and a pair of rigid braces, each rigid brace coupled to a corresponding frame coupler and hinged together at respective first ends. The rigid braces are electrically insulated from each other and are configured to conduct electrical power from the overhead support and charging system to the humanoid robot. In certain embodiments, each rigid brace comprises a hinged portion located at the first end, a first transition portion extending outward from the hinged portion, a vertical portion, a second transition portion extending inward from the vertical portion, and an attachment portion located at a second end configured to couple to the corresponding frame coupler. The rigid braces may be covered by an electrically insulating cover to prevent accidental electrical contact, the electrically insulating cover comprising a polymer selected from rubber, plastic, or a ceramic coating. The frame couplers may be configured to provide both mechanical contact and electrical continuity with the rigid braces through direct metal-on-metal contact, and the frame couplers may be fabricated from a high-strength material selected from steel or a reinforced composite.

In a further aspect, a harness for a humanoid robot is provided. The harness comprises a chest portion configured to be arranged over an upper chest region of a torso of the humanoid robot, a back portion configured to be arranged over an upper back region of the torso, and a pair of shoulder straps joining the chest portion and the back portion. A pair of frame couplers each include a waist strap and a coupler configured to engage with a harness support on a waist of the humanoid robot. An integrated power bus includes electrical conductors connecting attachment anchors on the shoulder straps to the frame couplers. In certain embodiments, each coupler comprises a main body defining an aperture and an inner surface, a transverse body defining an inner surface, and an angular body with a projection extending therefrom configured to extend into a recess defined in the waist of the humanoid robot. Each frame coupler may further comprise a buckle configured to be positionable along the waist strap to provide an operator-adjustable fit to the torso, wherein the buckle is configured to removably couple to a retainer affixed to the back portion of the harness such that the buckle and retainer together form a quick-release coupler assembly. The attachment anchors may each include at least one electrical contact in electrical communication with a corresponding electrical conductor, the electrical contact being configured to electrically connect to an electrical conductor in a tether of an overhead support system.

In yet another aspect, a humanoid robot configured for use with an overhead support and charging system is provided. The humanoid robot comprises a torso assembly extending vertically between a waist and a head and neck assembly. An electronics assembly is housed within the torso assembly and includes a battery pack and a power distribution unit. A pair of frame couplers is positioned at an upper extent of the torso assembly and electrically connected to the battery pack via conductors. The frame couplers are configured to mechanically and electrically couple to a humanoid robot coupling assembly. In certain embodiments, the torso assembly has a total internal volume of more than 15 liters and less than 40 liters, and the battery pack has an energy capacity exceeding 2.5 kWh. The torso assembly may have an uninterrupted internal height of more than 250 mm and less than 350 mm, and the battery pack may provide an operational runtime of over 3.5 hours under normal operating conditions. Each frame coupler may provide a structural loop configured to be removably connected to rigid braces via retaining pins and may be in electrical communication with the battery pack through a corresponding conductor of a power bus.

In still another aspect, a tether system for connecting a humanoid robot to an overhead support and charging system is provided. The tether system comprises at least one electrical conductor configured to transmit charging power, at least one mechanically tensionable cable configured to provide mechanical support for the humanoid robot, and an electrical insulator covering the electrical conductor. A coupler at a distal end is configured to mechanically and electrically connect to a humanoid robot coupling assembly, and the tether is configured to be extended and retracted by a winch assembly. In certain embodiments, the mechanically tensionable cable comprises a material selected from rope, strap, wire, cordage, chain, webbing, or braided strands of elongated material, and the coupler includes a quick-attach mechanism configured to establish both mechanical support and electrical connectivity through a single unified coupler mechanism.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a front view of the humanoid robot of FIG. 1, and equipped with a first embodiment of a humanoid robot coupling assembly;

FIG. 7 is a front view of the torso of the humanoid robot of FIG. 1, and wherein the torso housing is rendered transparent to show a pair of frame couplers, a battery, and power conductors installed within the torso;

FIG. 8 shows the humanoid robot with the first embodiment of the humanoid robot coupling assembly, and wherein said humanoid robot coupling assembly is connected to an overhead support and charging system;

FIG. 9 is a front perspective view of the humanoid robot of FIG. 1, and equipped with a second embodiment of a humanoid robot coupling assembly;

FIG. 10 is a rear perspective view of the humanoid robot and the second embodiment of the humanoid robot coupling assembly of FIG. 9;

FIG. 11 is a bottom perspective side view of the humanoid robot coupling assembly of FIG. 9 coupled to the waist of the humanoid robot; and

FIG. 12 shows the humanoid robot with the second embodiment of the humanoid robot coupling assembly, and wherein said humanoid robot coupling assembly is connected to the overhead support and charging system of FIG. 8.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. Introduction

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for: (i) advanced robots capable of handling undesirable and hazardous tasks, (ii) advanced robots capable of generating data that can be utilized to develop cutting-edge artificial intelligence models (e.g., LLMs, VLMs, VLAs, and/or BAMs) to enable these robots to operate autonomously in human-centric environments, or (iii) advanced robots capable of partial or complete autonomy.

One aspect of advanced robotic autonomy is to provide the advanced robot with the capability to replenish or extend its own internal power reserves. As the robot operates, the onboard electrical and electromechanical systems consume power. As such, the robot should be provided with sufficient reserves of power to prevent motor, sensor, or processor malfunctions that could lead to a fall that could potentially damage the robot and/or people and objects in the robot's environment. Furthermore, the robot should be able to be recharged and return to work without requiring a human presence or distracting a human from other higher-level tasks that the robot may be freeing them to perform. However, in some use cases, the robot's tasks may deplete the battery before the task or work shift is complete. In such situations, the robot's operational performance and availability can be extended (in some cases indefinitely) by providing the robot with supplemental power while the robot remains on task.

The disclosed overhead support systems with wired charging capabilities solve or improve upon the shortcomings of dedicated charging systems that require the robot to physically leave its work area and tasks in order to recharge. As such, the overhead support system is designed to be locatable by the robot, provide recharging power to the robot, and (in some implementations) passively support the weight of the robot (e.g., allowing some or all of the robot's power-consuming electrical and electromechanical systems to at least partly shut down during recharging, thereby reducing recharging time and preventing falls). The disclosed docking station provides a stabilization frame or harness configured to mechanically and electrically engage the robot to an external (e.g., overhead) power tether. In general, the disclosed overhead support system allows the robot to receive supplemental power while the robot works. In some implementations, the robot can then relax its leg actuators to suspend its torso from the tether, to conserve power that would otherwise be consumed to keep the robot standing.

Various embodiments of the overhead support systems are designed to: (i) provide wired power to the robot for operation and/or recharging its onboard power reserves, (ii) prevent the wired connection from becoming a tripping hazard or otherwise become an impediment to the robot's tasks, (iii) stabilize the robot in a substantially upright (e.g., standing) configuration while some or all of the robot's onboard systems and actuators are in low or no-power mode, (iv) be portable. This configuration helps enhance the productivity, autonomy, and flexibility of humanoid robotic operations. For the above reasons, the design and arrangement of the disclosed overhead support systems and complementary features of the robot provide the disclosed robot with substantial benefits over conventional robots and charging systems.

### B. Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

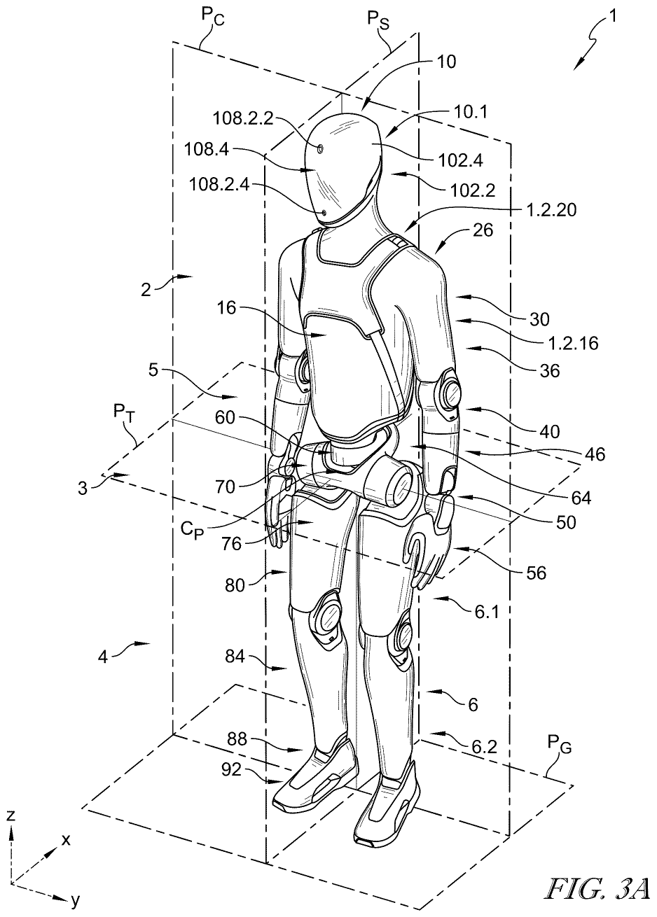

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (Pc) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cₚ) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. Robot(s) and Environment

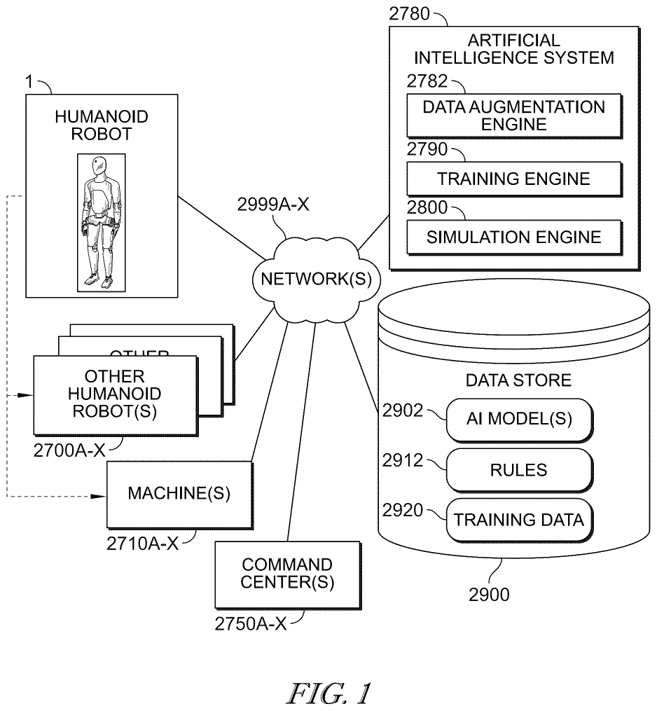

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/IL for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. Humanoid Robot

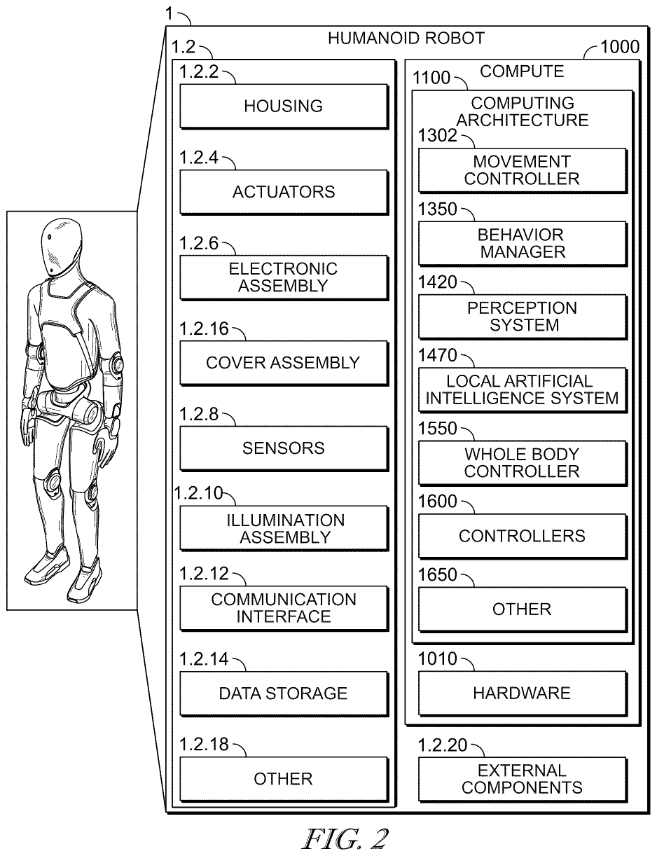

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central structural and functional component within the humanoid robot 1. It extends vertically between the waist 604 and the head and neck assembly 10, and it extends horizontally between the shoulders 26. The torso 16 is designed to provide the robot 1 with a generally humanoid shape, offer structural and operable support for the arm assemblies 5 and the head and neck assembly 10, and house and protect various internal components, including the arm actuators (J1) 190 and an electronics assembly 1.2.6 housed at least partially within the torso 16.

The electronics assembly 1.2.6, situated within the torso 16, contains various interconnected electronic components that are essential for the operation of the robot 1, including the battery pack 202, the compute 1000 (which includes one or more Central Processing Units (CPUs) and Graphics Processing Units (GPUs)), a power distribution unit, and a charging system. These components are strategically positioned within the volume of the torso 16 to optimize space utilization and maintain the robot's 1 center of gravity for balanced locomotion and manipulation. The battery pack 202 may be rearwardly offset, positioned in a rear section of the torso 16, while the compute 1000 is placed in a forward section. This specific spatial distribution helps to maintain a balanced posture, allows for efficient thermal management and cooling, and maximizes the available volume for the size and power density of the battery pack 202. A dedicated cooling system, such as one comprising heat pipes and heat sinks or a liquid cooling loop, may be integrated between the battery pack 202 and the compute 1000 to manage their respective thermal loads during operation. The electronics assembly 1.2.6 may be designed with a high degree of modularity, wherein individual components or subsystems can be independently accessed and replaced to facilitate easier maintenance, repair, and future upgrades. The charging system is configured to support both wired and wireless charging protocols. A wired charging system might use a physical docking station with conductive contacts, while a wireless system could utilize inductive charging principles, with induction coils that may be embedded in the housing of the torso 16 and/or the feet 92 of the robot 1. The charging system may also include a plurality of safety features, such as overcharge protection, thermal monitoring, and short-circuit prevention circuitry to ensure safe and reliable operation.

The torso 16 may have a total internal volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack 202 that exceeds 2 liters in volume, preferably more than 4 liters, and most preferably more than 6 liters in volumetric capacity. Consequently, the humanoid robot 1 may incorporate a battery pack 202 with an energy capacity exceeding 2.5 kWh, which may provide an operational runtime of over 3.5 hours under normal operating conditions, and preferably more than 4.5 hours, and most preferably more than 6 hours. In some implementations, the torso 16 may adopt a quasi-trapezoidal prism configuration, wherein its front surface area is smaller than its back surface area, with angled side shrouds connecting these two sections. This specific geometric design may enhance the kinematic range of motion of the robot 1, particularly by improving its ability to reach across its own body without self-collision.

The interior of the torso 16 is substantially filled by an electronics sub-volume 330 that is located below the shoulders 26 and above the waist 604. The electronics sub-volume 330 contains a battery 202, a power bus 202.2, various ones of the actuators, the electronics assembly 1.2.6, the communication interface 1.2.12, and data storage 1.2.14, and has a substantially prism or cylindrical shape. The power bus 202.2 includes a first conductor 202.2.2 that electrically connects the battery 202 to a first frame coupler 172.8a, and a second conductor 202.2.4 that electrically connects the battery 202 to a second frame coupler 172.8b.

a. Humanoid Robot Coupling Assembly

The humanoid robot coupling assembly 180 disclosed herein is designed to be positioned between and coupled to both an upper extent of the robot's torso 16 and an overhead support and charging system 10000. This positional and coupling arrangement allows the humanoid robot 1 to move freely within its environment and receive electrical power (e.g., for charging the battery 202), while concurrently limiting the potential vertical displacement of the robot 1 if the robot becomes unstable, loses balance, stumbles, slips, or falls. Additionally, unlike conventional robot tethers that are coupled to the neck or arms, the disclosed humanoid robot coupling assembly 180 is coupled directly to the structural frame via the torso 16 of the robot 1. This attachment methodology helps ensure that said humanoid robot coupling assembly 180 does not limit the robot's range of motion or cause damage to the arms 5 or the head and neck assembly 10 of the robot 1 during operation or a fall event. In some embodiments, the humanoid robot coupling assembly 180 can also provide a conduit for high-bandwidth wired communications between the robot 1 and an external communication network.

The humanoid robot coupling assembly 180 includes (i) a pair of frame couplers, designated as 172.8a and 172.8b, which are coupled to the shoulders 26, and (ii) a pair of rigid braces, designated as 182.2a and 182.2b, which are coupled to the frame couplers 172.8a and 172.8b, respectively. Accordingly, the frame couplers 172.8a and 172.8b are designed as robust structural members, fabricated from a high-strength material such as steel or a reinforced composite, that can support the entire weight of the robot 1 and will not substantially deform considering the stresses placed on said members if the robot 1 needs to be suspended for maintenance reasons or if it experiences a fall.

i. Rigid Braces

The humanoid robot coupling assembly 180 includes a pair of rigid braces 182.2a and 182.2b, wherein each brace 182.2a, 182.2b is designed to be coupled to a corresponding frame coupler 172.8a, 172.8b. The humanoid robot coupling assembly 180 is configured to be spaced away from the robot head 10 and coupled to frame couplers 172.8a and 172.8b, wherein said frame coupler 172.8a is positioned at a right upper extent of the robot torso 16, and wherein said frame coupler 172.8b is positioned at a left upper extent of the robot torso 16. The humanoid robot coupling assembly 180 is configured to at least pivot at the frame couplers 172.8a, 172.8b to allow robot 1 to move freely without impeding the movement of the head 10 or otherwise restraining robot 1 while it performs tasks during normal operation. The humanoid robot coupling assembly 180 is configured to be attached to the overhead support and charging system 10000 to provide recharging power to the robot 1 for tasks that may rapidly deplete the battery 202 (e.g., before a work shift is complete).

The two rigid braces 182.2a and 182.2b are hinged together at respective first ends 182.2.2. Overall, each of the braces 182.2a and 182.2b includes: (i) a hinged portion 182.2.4 located at the first end 182.2.2, (ii) a first transition portion 182.2.6, (iii) a vertical portion 182.2.8, (iv) a second transition portion 182.2.10, and (v) an attachment portion 182.2.12 located at a second end 182.2.14. Each of the braces 182.2a, 182.2b extends from the hinged portion 182.2.4 and is shaped to mirror the other brace with respect to a center plane. For example, the center plane 182.4 may be the sagittal plane of the robot 1. The first transition portion 182.2.6 of each brace 182.2a, 182.2b extends outward from the hinged portion 182.2.4 (e.g., away from the center plane) to respective vertical portions 182.2.8. The second transition portion 182.2.10 extends inward (e.g., toward the center plane) from the vertical portion 182.2.8 to the attachment portion 182.2.12. For example, the second transition portion 182.2.10 extends inward toward the center plane and the robot head 10, without making physical contact with the robot head 10. The attachment portion 182.2.12 is configured to couple the humanoid robot coupling assembly 180 to the robot 1 at a frame coupler 172.8 coupled to the robot 1. In various embodiments, a hinge axis (Y-Y) defined in the hinged portion 182.2.4 is oriented perpendicular to an attachment axis (X-X) defined in the attachment portion 182.2.12.

The two rigid braces 182.2a and 182.2b are electrically insulated from each other by an insulator 182.2.4.10 located at the hinged portion 182.2.4. For example, the rigid brace 182.2a can be positively charged while the rigid brace 182.2b can be negatively charged without causing a direct electrical short circuit between the two. The rigid braces 182.2a and 182.2b are covered by an electrically insulating cover or coating 182.2.20 (e.g., a polymer such as rubber or plastic, or a ceramic coating) to prevent accidental electrical contact. In some embodiments, dedicated wires or other electrical conductors can be used in addition to or in place of the structurally rigid braces 182.2a and 182.2b to provide electrical connectivity to the frame couplers 172.8a and 172.8b.

ii. Frame Couplers

The frame couplers 172.8a and 172.8b each provides a structural loop that can be removably connected to the rigid braces 182.2a, 182.2b via retaining pins or clips 182.8. Unlike conventional robots, the generally U-shaped or C-shaped humanoid robot coupling assembly 180 is not integrally formed with an extent of the torso 16. This detachable design allows said humanoid robot coupling assembly 180 to be removed from the robot 1 when it is not needed. Said U-shaped or C-shaped humanoid robot coupling assembly 180 includes a first rigid brace 182.2a and a second rigid brace 182.2b designed to be coupled to the overhead support and charging system 10000. The rigid design of the braces 182.2a and 182.2b provides substantial benefits over conventional robot tethers that are formed from deformable materials (e.g., chains or fabric), wherein one of these substantial benefits includes preventing the tether from damaging the robot's neck or head 10 during a fall. Additionally, the disclosed braces are not designed in a manner that places their portions solely perpendicular to the floor; Instead, the braces 182.2a and 182.2b include complex bends in both the sagittal and coronal planes to help ensure that the braces cannot contact the neck or head 10 during a fall and to help ensure that a screen that may be contained within the head 10 is viewable from the sides of the robot 1. However, and as will be discussed in more detail below, it should be understood that flexible cables may be used in connection with the frame couplers 172.8a and 172.8b instead of the rigid humanoid robot coupling assembly 180.

As described above, the frame coupler 172.8a is in electrical communication with the conductor 202.2.2, and the frame coupler 172.8b is in electrical communication with the conductor 202.2.4. The conductors 202.2.2 and 202.2.4 provide positive and negative electrical connections between the battery 202 and the frame couplers 172.8a, 172.8b for receiving charging power, as will be discussed in more detail below. In some embodiments, the mechanical contact between the frame couplers 172.8a, 172.8b and the rigid braces 182.2a, 182.2b can also provide electrical continuity (e.g., through direct metal-on-metal contact). In some embodiments, the frame couplers 172.8a, 172.8b and the rigid braces 182.2a, 182.2b can include one or more discrete electrical connectors (e.g., mating electrical plugs) or dedicated contacts (e.g., electrical pogo pins, electrical wipers) to provide reliable electrical continuity. In some embodiments, the frame couplers 172.8a, 172.8b and the rigid braces 182.2a, 182.2b can include electrical coils configured to transfer electrical energy wirelessly between the robot 1 and the rigid braces 182.2a, 182.2b. For example, the rigid brace 182.2a can include a primary transformer coil and the frame coupler 172.8a can include a secondary transformer coil, such that when the rigid brace 182.2a is mechanically coupled to the frame coupler 172.8a, a transformer arrangement is configured to permit an electrical current passed through the primary coil in the rigid braces 182.2a, 182.2b to induce an electrical current in the secondary coil in the robot 1, which can be used to recharge the battery 202.

Unlike conventional robot tethers, the disclosed humanoid robot coupling assembly 180 is detachable from the robot 1 and can be utilized temporarily or attached to a different robot if the operational needs have changed. For example, the humanoid robot coupling assembly 180 can be utilized to provide support and/or supplementary power when the robot 1 is tasked with operations that may deplete the battery 202 before a work shift is complete, and then be removed when the robot 1 is reassigned to tasks that are less power intensive. The humanoid robot coupling assembly 180 may also be utilized in certain situations in which wired communications to and from the robot 1 may be advantageous (e.g., in high-security environments in which wireless communications are not permitted).

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, lower | A₄ |
| | | | humerus | |
| (J5) 468 | 2 | lower arm twist | lower arm x, lower arm roll | A₅ |
| (J6) 484 | 2 | wrist flex | wrist/hand y, wrist/hand pitch, | A₆ |
| | | | flick | |
| (J7) 520 | 2 | wrist pivot | wrist/hand z, wrist/hand yaw, | A₇ |
| | | | wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward | A₁₁ |
| | | | kick | |
| (J12) 768 | 2 | hip roll | hip x, hip/leg roll, sideways | A₁₂ |
| | | | kick | |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first | A₁₅ |
| | | | ankle | |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts.

A substantial majority of the actuators 1.2.4 (e.g., about twenty-eight of the forty-two actuators or about 66.7% of the actuators) in the illustrative embodiment robot 1 are not connected to a drive linkage; instead, they directly drive the associated part of the robot 1. Conversely, in the illustrative embodiment robot 1, fourteen of the forty-two actuators 1.2.4, or about 33.3% (but more than 10%, and preferably more than 25%), of the rotary actuators are coupled to a drive linkage. Drive linkages are coupled to an aggregate total of twelve rotary actuators contained within both hands 56 and to the foot flex actuators (J15) in each shin 84. These drive linkages allow: (i) the fingers and thumb to be under-actuated, meaning they retain the ability to flex, curl, or rotate around an object while eliminating the need for an actuator to control each joint or degree of freedom, and (ii) the foot 92 to pivot around an axis that is located well forward (e.g., more than 10% of the overall length of the foot) of the center of the drive linkage.

The robot 1 only uses electric actuators, and thereby lacks manual, hydraulic, cable-based, or pneumatic actuators. The exclusive use of electric actuators reduces assembly, maintenance, weight, and cost, and increases durability and safety considerations related to operating the robot 1 within or around other humans.

ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D30@; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about −120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

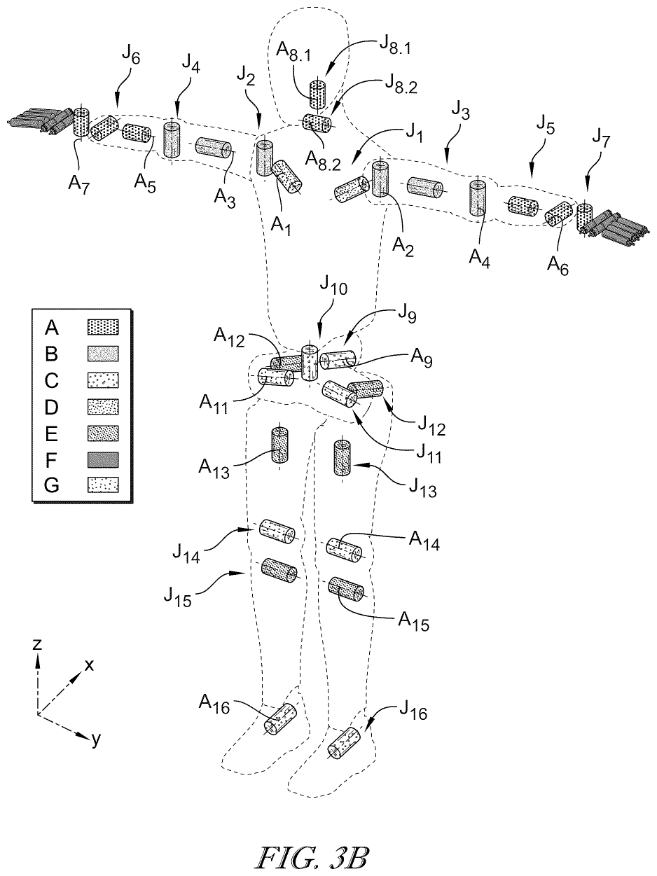

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

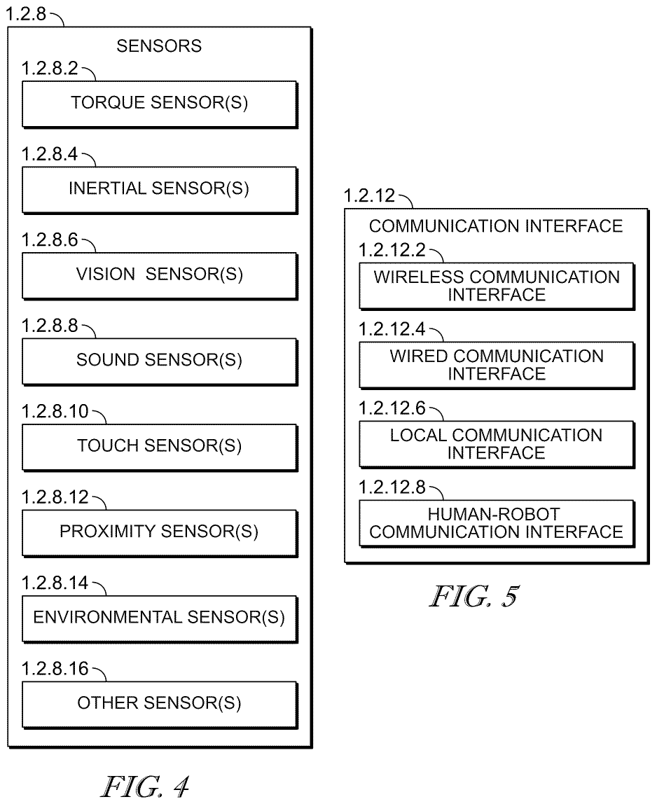

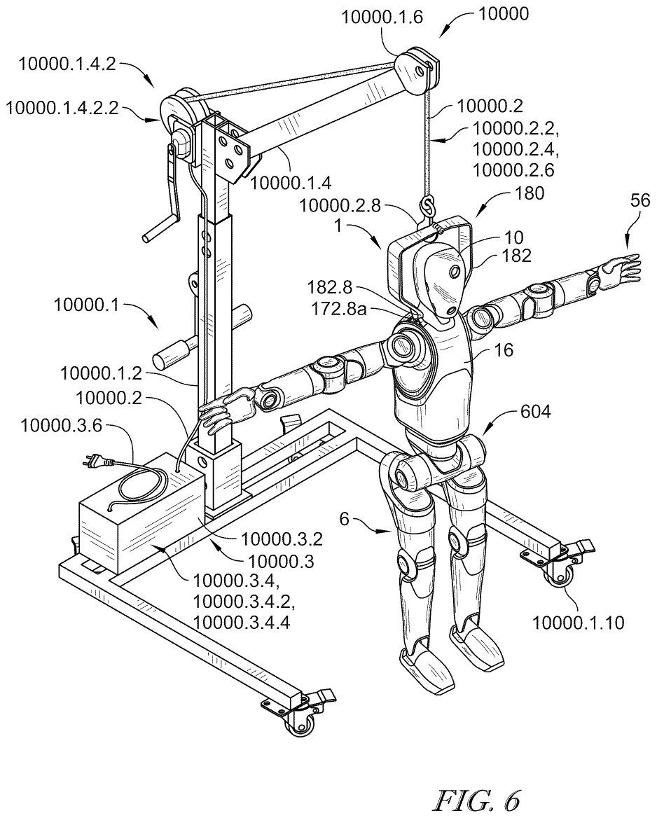

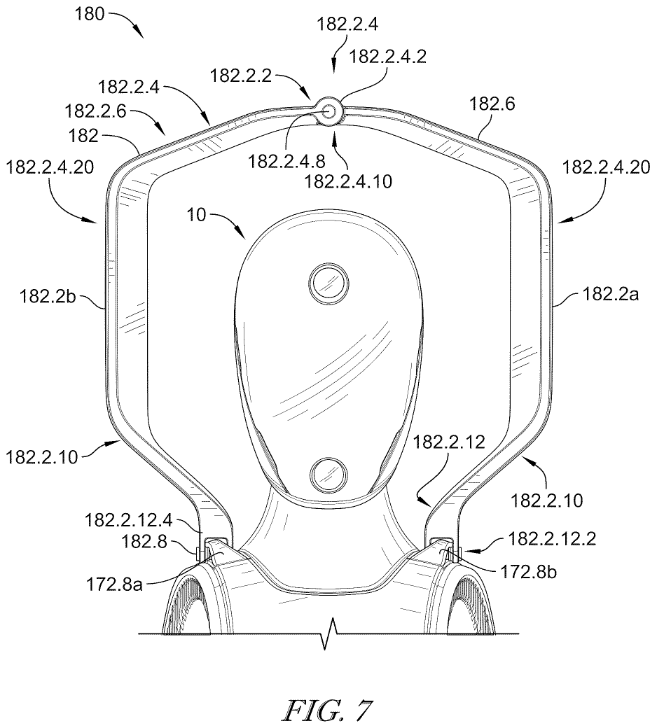

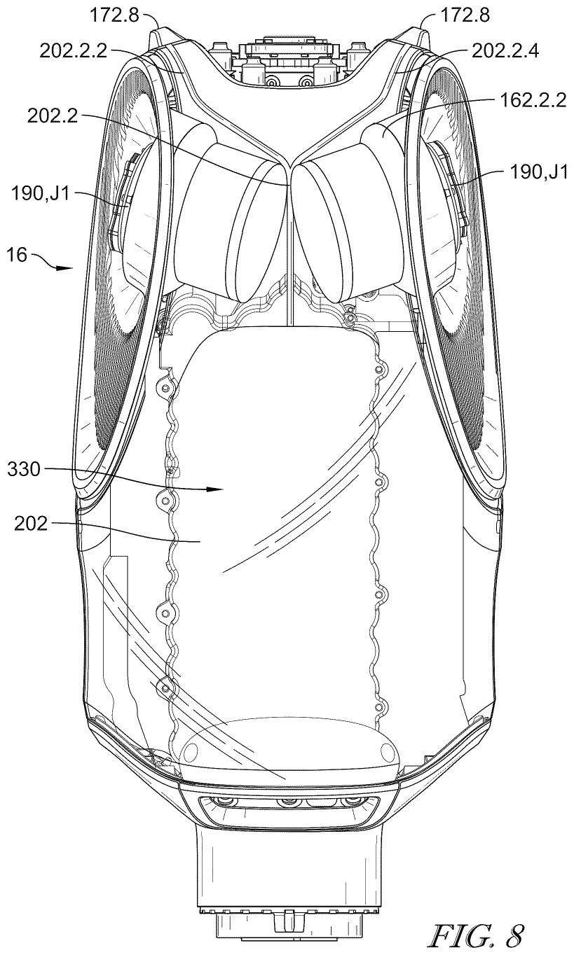

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### E. Overhead Support and Charging System

The humanoid robot coupling assembly 180 is configured to be attached to an overhead support and charging system 10000 to provide electrical power to the robot 1, and in some implementations, to limit unexpected movement and reduce potential damage to the robot 1 in the event of an unplanned occurrence that may cause robot 1 to become unstable or fall. The overhead support and charging system 10000 includes a (i) base 10000.1, (ii) a tether 10000.2, and (iii) a power electronics assembly 10000.3. The interplay among these three principal subsystems enables the overhead support and charging system 10000 to deliver sustained electrical power, mechanical fall protection, and operational flexibility to the robot 1 during a range of work scenarios.

a. Base

In the illustrated example, the base 10000.1 is shown as a portable crane, but in some embodiments, the base 10000.1 can be a fixed gantry, a rail system, a cable-based tether system, or any other similar system that is mounted to a supportive overhead structure (e.g., a ceiling or structural truss). The base 10000.1 includes a vertical arm 10000.1.2 that supports a horizontal cantilever arm 10000.1.4. The vertical arm 10000.1.2 extends from a ground-engaging support structure and provides the elevation for the cantilever arm 10000.1.4 to position the tether 10000.2 above the robot 1 during use. The cantilever arm 10000.1.4 extends away from the vertical arm 10000.1.2 at a first end, and includes a pulley 10000.1.6 at a distal end to guide the tether 10000.2. The pulley 10000.1.6 is rotatably mounted at the distal end of the cantilever arm 10000.1.4 and is configured to reduce friction and wear on the tether 10000.2 as the tether 10000.2 is extended and retracted during operation.

b. Tether

The robot 1 is connected to the base 10000.1 by at least one tether 10000.2. The tether 10000.2 includes at least one electrical conductor 10000.2.2 (e.g., a positive wire, a negative wire, a ground wire, and communication bus wires) that is electrically connected to the rigid braces 182.2a and 182.2b. For example, a positive conductor can be electrically connected to the rigid brace 182.2a, and a negative conductor can be electrically connected to the rigid brace 182.2b. The electrical conductor 10000.2.2 and/or the entire tether 10000.2 is covered by an electrical insulator 10000.2.6 to protect against accidental contact that can lead to an electrical short or electrocution. The electrical insulator 10000.2.6 may be formed from a durable polymer material, such as a cross-linked polyethylene or a thermoplastic elastomer, and is configured to maintain dielectric integrity over repeated flexion cycles encountered during extension and retraction of the tether 10000.2.

In addition to electrical power, the tether 10000.2 can also carry data or other communication signals between the overhead support and charging system 10000 and the robot 1. For example, the tether 10000.2 can include one or more discrete communication conductors to provide a low or high bandwidth communication bus (e.g., CAT5/6/7 Ethernet, USB, I2C, CAN, MODBUS). In some embodiments, data signals can be carried over the charging power conductors (e.g., using power line communications). Such data connections can be used to offload large amounts of data from the robot 1 (e.g., sensor logs) or to push large amounts of data to the robot 1 (e.g., major firmware updates). In some implementations, the tether 10000.2 can be used to carry command and control information to the robot 1, such as teleoperation commands or other remote commands.

The tether 10000.2 also includes at least one cable 10000.2.4 or other flexible and mechanically tensionable member (e.g., a rope, strap, wire, cordage, chain, webbing, braided strands of elongated material, or other suitable means of attachment). The cable 10000.2.4 is configured to provide mechanical support for the robot 1, such as to carry the suspended weight of the robot 1 (e.g., during powered-down recharging or in the event of an accidental fall). The cable 10000.2.4 may be rated to bear a load that exceeds the total mass of the robot 1 by a predetermined safety factor (e.g., a factor of at least two to five times the static weight of the robot 1). This positional, electrical, and mechanical coupling arrangement allows the humanoid robot 1 to move freely within its environment while providing charging power that can partly or indefinitely extend the robot's electrical endurance. This arrangement also limits the potential vertical displacement of the robot 1 if the robot 1 becomes unstable, loses balance, stumbles, slips, or falls. Such a feature can enhance the safety and efficiency of testing and training operations for the robot 1, when the robot 1 may need to exert an unusual amount of energy and/or for an unusual amount of time, all while performing (possibly experimental) tasks that may have an increased risk of leading to a fall or while performing debug testing of new (and potentially imperfect) operational software.

Additionally, unlike conventional robot tethers that are coupled to the neck or arms, the disclosed humanoid robot coupling assembly 180 is coupled to the torso 16 of the robot 1. This helps ensure that the humanoid robot coupling assembly 180 does not limit the robot's range of motion or damage the arms 5 or neck/head 10 of the robot 1. By coupling to the torso 16, the humanoid robot coupling assembly 180 positions the mechanical and electrical interface near the robot's center of mass, which may improve stability during both tethered operation and suspended recharging.

The tether 10000.2 is configured to be extended, retracted, and held at set extensile positions by a winch assembly 10000.1.4.2. The winch assembly 10000.1.4.2 includes a rotatable electrical interface 10000.1.4.2.2 (e.g., a set of slip rings) that can permit the winch assembly 10000.1.4.2 to rotate as it is used to play out and gather up the tether 10000.2, while maintaining electrical conductivity and continuity for the conductors within. In the illustrated example, the winch assembly 10000.1.4.2 is shown as a manually, hand-cranked winch. Such an arrangement may be useful to simplify the construction and reduce the cost of the overhead support and charging system 10000. In some embodiments, the winch assembly 10000.1.4.2 can be a motorized (electrically) winch assembly to ease the raising and lowering of the tethered robot 1 and/or to dynamically control the amount of “slack” provided to the robot 1 so it can travel freely within the reach of the tether 10000.2. For example, the robot 1 may sense or otherwise determine the position of the overhead support and charging system 10000 relative to its own position to determine how far away the robot 1 is from the overhead support and charging system 10000, and this distance can be used by the overhead support and charging system 10000 or the robot 1 to control the winch assembly 10000.1.4.2 to provide an appropriate length of the tether 10000.2. Similarly, when the robot 1 needs to move in a way that increases or decreases its distance from the overhead support and charging system 10000, the robot 1 can communicate with the overhead support and charging system 10000 to request that the winch 10000.1.4.2 make a corresponding change in the length of the tether 10000.2 (e.g., to provide additional tether length to permit movement away, or to gather up excess tether length upon approach). In some implementations, the speed as well as the direction of operation of the winch assembly 10000.1.4.2 can be controlled such that the extension or retraction of the tether 10000.2 is substantially proportional to the speed of the robot's 1 movements away from or toward the overhead support and charging system 10000.

The tether 10000.2 extends from the power electronics assembly 10000.3, through the winch assembly 10000.1.4.2, over the cantilever arm 10000.1.4 and the pulley 10000.1.6, to a coupler 10000.2.8 at its distal end. The coupler 10000.2.8 is configured to mechanically and electrically connect the tether 10000.2 to the rigid braces 182.2a, 182.2b. In some embodiments, the coupler 10000.2.8 can include a quick-attach mechanism, in which both mechanical support and electrical connectivity are established through a single, unified coupler mechanism. In some embodiments, the coupler 10000.2.8 can include separate connections for mechanical and electrical connectivity. For example, the coupler 10000.2.8 can include a hook connected to the cable 10000.2.4 or rope of the tether 10000.2 to couple to the rigid braces 182.2a, 182.2b to provide mechanical suspension, and can include one or more separate electrical connectors that can be plugged into corresponding electrical connectors on the rigid braces 182.2a, 182.2b. In embodiments that employ separate connections, the mechanical coupling may be established before or after the electrical coupling, and the overhead support and charging system 10000 may be configured to confirm that both couplings are secure before initiating power transfer.

In some embodiments, the coupler 10000.2.8 itself can be electrically conductive and used to conduct electrical power from the tether 10000.2 directly to the frame couplers 172.8a and/or 172.8b (e.g., through suspensive contact between the coupler 10000.2.8 and the frame couplers 172.8a and/or 172.8b) and can be covered by an electrically insulating layer. For example, the frame couplers 172.8a and/or 172.8b can be metallic and the coupler 10000.2.8 can be metallic, such that when the coupler 10000.2.8 is mechanically coupled to the frame couplers 172.8a and/or 172.8b, an electrical connection is also formed. In such configurations, the direct metal-on-metal contact between the coupler 10000.2.8 and the frame couplers 172.8a and/or 172.8b provides both structural support and electrical continuity through a single interface.

In certain embodiments, the frame couplers 172.8a, 172.8b or the rigid braces 182.2a, 182.2b may be configured with an electromagnetic quick-release mechanism for enhanced operational flexibility and safety. In such configurations, one or more electromagnets are integrated into or positioned adjacent to the attachment points on the frame couplers 172.8a, 172.8b, the rigid braces 182.2a, 182.2b, or other designated locations. Correspondingly, the mating component of the coupling system (e.g., the coupler 10000.2.8, a connecting carabiner, or hook) would incorporate a compatible ferromagnetic element. During normal operation, the electromagnets are energized, generating a strong magnetic field that securely holds the tether's ferromagnetic component, thereby establishing a robust connection capable of supporting operational loads, including the robot's 1 weight. However, for emergency release scenarios (such as entanglement, imminent hazard, or system malfunction) or for rapid reconfiguration or detachment needs, the electrical current supplied to the electromagnets can be intentionally interrupted. This interruption instantly collapses the magnetic field, thereby releasing the tether component from the frame couplers 172.8a, 172.8b and/or the rigid braces 182.2a, 182.2b with minimal delay or physical force. The control signal to de-energize the electromagnets could be initiated manually by an operator, triggered automatically by the robot's onboard safety systems upon detection of predefined conditions, or activated via a remote command, offering a versatile and rapid means of detachment compared to conventional mechanical latching mechanisms.

c. Power Electronics Assembly

The power electronics assembly 10000.3 is removably affixed to the base 10000.1. The power electronics assembly 10000.3 includes a (i) shell 10000.3.2, (ii) electronic subsystems 10000.3.4, and (iii) a power cord 10000.3.6. The removable affixation of the power electronics assembly 10000.3 to the base 10000.1 permits the power electronics assembly 10000.3 to be serviced, replaced, or upgraded without disassembling the base 10000.1.

i. Shell

The shell 10000.3.2 is configured as a mechanically protective and electrically insulating housing for the electronic subsystems 10000.3.4. The shell 10000.3.2 may be fabricated from a rigid polymer, a sheet metal enclosure with an insulating liner, or a composite material selected to provide both impact resistance and electrical isolation. The shell 10000.3.2 encloses the electronic subsystems 10000.3.4 to shield them from external mechanical forces, dust, moisture, and electromagnetic interference.

In some embodiments, the shell 10000.3.2 can partly define a substantially sealed or environmentally isolated internal space, in accordance with various industrial standards. For example, the shell 10000.3.2 can be part of a sealing arrangement that provides an ingress protection (IP) rating such as IP65, IP68, or IP69, and/or a National Electrical Manufacturers' Association (NEMA) rating such as NEMA 4 or NEMA 6. Such environmental isolation can promote the longevity and reliability of the electronic subsystems 10000.3.4, as the overhead support and charging system 10000 is configured to be located near or within the workspace of the robot 1, and some workspaces can expose the overhead support and charging system 10000 to environmental contaminants. For example, on an industrial work floor, the overhead support and charging system 10000 may be exposed to dropped work materials (e.g., lost fasteners), sawdust, metal shavings, paint overspray, dust, and/or smoke. In another example, in a domestic or retail environment, the overhead support and charging system 10000 may be exposed to contaminants such as dust, carpet fibers, liquid spills, pet dander, and/or human hair. In yet another example, in an outdoor environment (e.g., a farm), the overhead support and charging system 10000 may be exposed to contaminants such as dirt, dust, insects, and/or rain.

In some embodiments, the shell 10000.3.2 can incorporate active and/or passive cooling systems to regulate temperatures within its interior. For example, fans, heat spreaders, heat sinks, heat pipes, or combinations of these and/or any other appropriate heat management apparatus can be included to transport or remove heat energy from the interior of the shell 10000.3.2 (and the electronic subsystems 10000.3.4 contained therein) to the surrounding ambient environment. The selection of a particular cooling strategy may depend upon the power throughput of the electronic subsystems 10000.3.4 and the ambient temperature range of the intended operating environment.

ii. Electronic Subsystems

The electronic subsystems 10000.3.4 serve as the central, protected hub for the charging electronics of the overhead support and charging system 10000, housing the primary printed circuit board assemblies (PCBAs). These PCBAs include the overhead support system's high-power power conversion electronics 10000.3.4.2 and the system's central computer 10000.3.4.4. The power conversion electronics 10000.3.4.2 are configured to transform input AC or DC power into regulated DC output power at a voltage and current appropriate for charging the battery 202 of the robot 1. This computer acts as the brain of the overhead support and charging system 10000, managing the complex charging logic, which includes negotiating power delivery levels with the robot 1 and monitoring component temperatures in real-time. It also constantly monitors system health and communicates with the robot 1 to exchange status information.

The central computer 10000.3.4.4 may include any combination of hardware, software, and firmware circuitry to perform various computing functions that enable the power electronics assembly 10000.3 to operate semi- or fully-autonomously. Such functions may include current limiting, load balancing, coordinating with other charging stands, processing sensor information, communicating with the humanoid robot 1 based on the sensor information and operational goals, controlling the activation or deactivation of electrical components, and policy management. The central computer 10000.3.4.4 may further perform fault detection, thermal protection, and overcurrent protection functions as part of a comprehensive safety monitoring subsystem.

The central computer 10000.3.4.4 may operate as one or more general purpose processors or special purpose processors (e.g., digital signal processors, application specific integrated circuits (ASICs), field programmable gate arrays (FPGAs), etc.) that can be configured to execute computer-readable program instructions stored in associated data storage devices. Such instructions can be executed to provide controller operations (e.g., to activate or deactivate components of the mechanical and electrical architecture of the overhead support and charging system 10000, etc.). Specifically, the overhead support and charging system 10000 may be configured with a variety of processors such as one or more central processing units (CPUs) (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), and neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

The central computer 10000.3.4.4 may incorporate machine learning algorithms to analyze historical charging data, adapt power delivery parameters, and optimize charging performance over time. By monitoring factors such as the robot's movement patterns, battery charge-discharge cycles, and environmental influences, the system can fine-tune parameters such as duty cycle, voltage, and resonance tuning. Predictive analytics could be employed to preemptively adjust charging characteristics, extending battery longevity while ensuring rapid energy replenishment when needed. The central computer 10000.3.4.4 may also store and reference charging profiles corresponding to different battery chemistries or capacities, such that the overhead support and charging system 10000 can adapt its power delivery to different robot configurations.

iii. Power Cord

A power cord 10000.3.6 extends from the power electronics assembly 10000.3. The power cord 10000.3.6 is strategically placed to minimize its profile and to prevent it from becoming a trip hazard in a busy workspace. In some embodiments, the power cord 10000.3.6 can include a plug (not shown) to enable the power electronics assembly 10000.3 to receive power from a standard wall outlet (e.g., NEMA 5-15, NEMA 5-20, NEMA 14-50, CEE 7/2, GB 1002, GB 2099.1). In some alternative embodiments, the power cord 10000.3.6 can be configured to be wired directly into an electrical junction box for a more permanent installation. The power cord 10000.3.6 may include strain relief features at its connection to the power electronics assembly 10000.3 to prevent conductor fatigue and disconnection during repositioning of the overhead support and charging system 10000.

d. Caster Wheels

In the illustrated example, the base 10000.1 is shown as a portable crane, supported by a collection of caster wheels 10000.1.10. The caster wheels 10000.1.10 are configured to permit rolling, lateral movement of the overhead support and charging system 10000. In some implementations, the caster wheels 10000.1.10 can enable a human operator or the robot 1 to push the overhead support and charging system 10000 to a predetermined location for use (e.g., a specific robot 1 work location). In some implementations, the robot 1 may be configured to walk while still tethered to the overhead support and charging system 10000, effectively towing the overhead support and charging system 10000 and causing it to travel with the robot 1 to a new location. The caster wheels 10000.1.10 may include locking mechanisms to hold the overhead support and charging system 10000 in a fixed position once it has been moved to a desired location.

e. Operation of Tethered Power Transfer

In use, the rigid braces 182.2a, 182.2b are coupled to the robot 1 at the frame couplers 172.8a and 172.8b, such that the braces 182.2a and 182.2b are mechanically and electrically coupled to the robot 1. The humanoid robot coupling assembly 180 is also coupled to the tether 10000.2 by the coupler 10000.2.8 to mechanically and electrically couple the robot 1 to the tether 10000.2 of the overhead support and charging system 10000. The winch 10000.1.4.2 is operated to adjust the amount of mechanical support that the overhead support and charging system 10000 provides to the robot 1 (if any), and/or how much additional length of the tether 10000.2 is provided to allow the robot 1 to travel. In some scenarios, the winch 10000.1.4.2 may be operated to provide full weight support for the robot 1, partial weight support, or no weight support (e.g., providing tether slack for free-roaming operation with a charging-only connection).

The power electronics assembly 10000.3 is operative to perform the function of converting utility power into charging power suitable for the robot 1 and its battery 202. The power electronics assembly 10000.3 is configured to receive electrical power from a conventional alternating current (AC) source, such as a standard wall outlet providing, for example, 90-264 volts AC at a frequency of 47-63 Hz. The input power is first subjected to an electromagnetic compatibility (EMC) filter stage, which may be constituted by components including, but not limited to, X/Y capacitors, common-mode chokes, and a Metal Oxide Varistor (MOV), for the purpose of suppressing electromagnetic noise and protecting against transient voltage surges. Subsequent to filtration, the alternating current is converted to direct current (DC) by means of a bridge rectifier. In certain instantiations, a Power Factor Correction (PFC) circuit may be disposed downstream of the rectifier to ensure an efficient power draw from the mains, thereby establishing a stable, high-voltage DC bus, which may be on the order of 30V, 45V, 60V, 120V, 240V, 400 volts DC. Furthermore, it is contemplated that in some embodiments, the power supply electronics may incorporate an auxiliary power supply, such as a flyback converter, for the generation of various low-voltage DC rails (e.g., 12V, 5V, 3.3V) for the energization of the control electronics, microcontrollers (MCUs), and any associated cooling fans of the electronics assembly 10000.3.

The flow of energy and data within the system is controlled by the central computer 10000.3.4.4, which is disposed within electronics assembly 10000.3. A primary power pathway originates at the power conversion electronics 10000.3.4.2, proceeds through the tether 10000.2, the braces 182.2a and 182.2b, the frame couplers 172.8a and 172.8b, the conductors 202.2.2 and 202.2.4, and culminates at the battery 202. A control and communication pathway is configured to be bidirectional. The compute module 1000 of the robot 1 is configured to continuously monitor its operational status, including but not limited to received voltage, battery charge state, and internal temperatures, and to transmit this information back to the central computer 10000.3.4.4 as part of a closed-loop control architecture. This feedback mechanism permits the power electronics assembly 10000.3 to effect real-time adjustments to the transmitted power, and further enables the cooperative monitoring by both systems for fault conditions, thereby facilitating the immediate termination of power transfer should a hazardous condition be detected. It is to be understood that in various embodiments, said communication may be achieved through a plurality of protocols, including, for example, a Controller Area Network (CAN), the RS422 standard, RS485, RS232, I2C, Ethernet, or a dedicated wireless communication link.

### F. Alternative Humanoid Robot Coupler Assembly

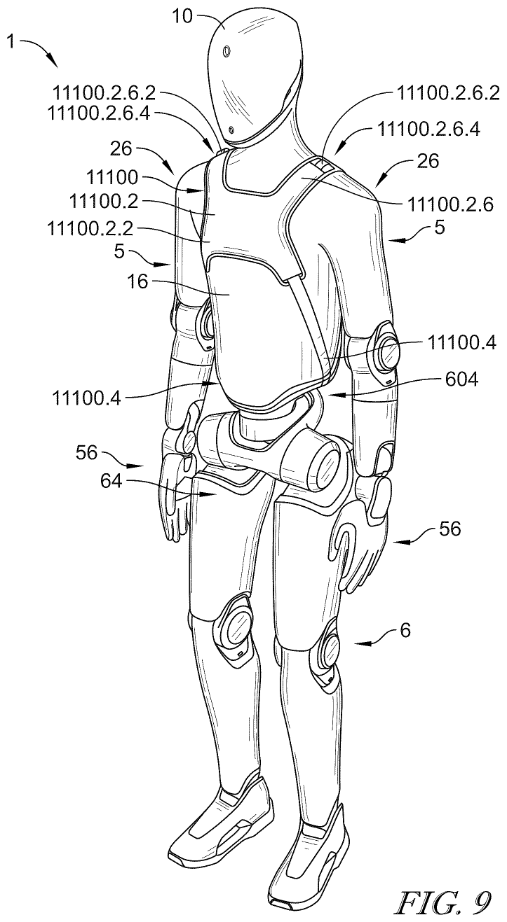

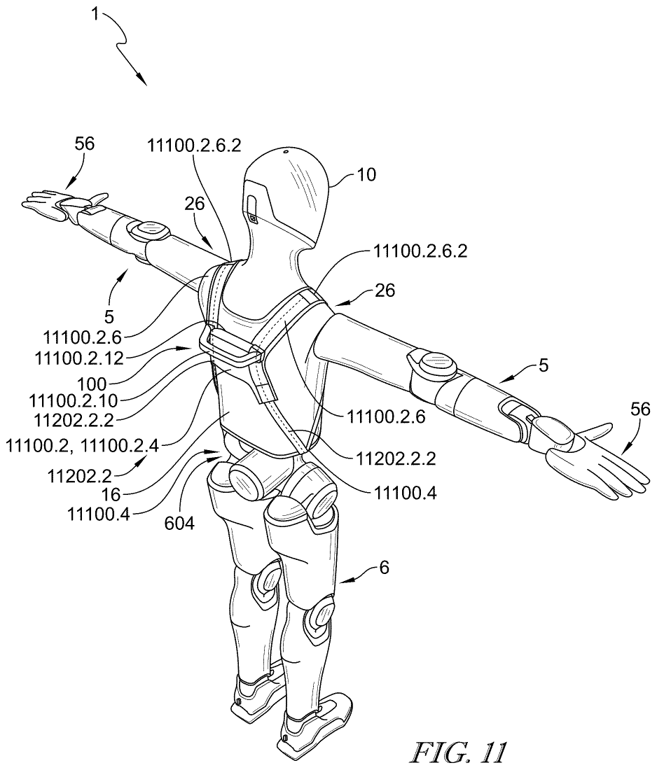

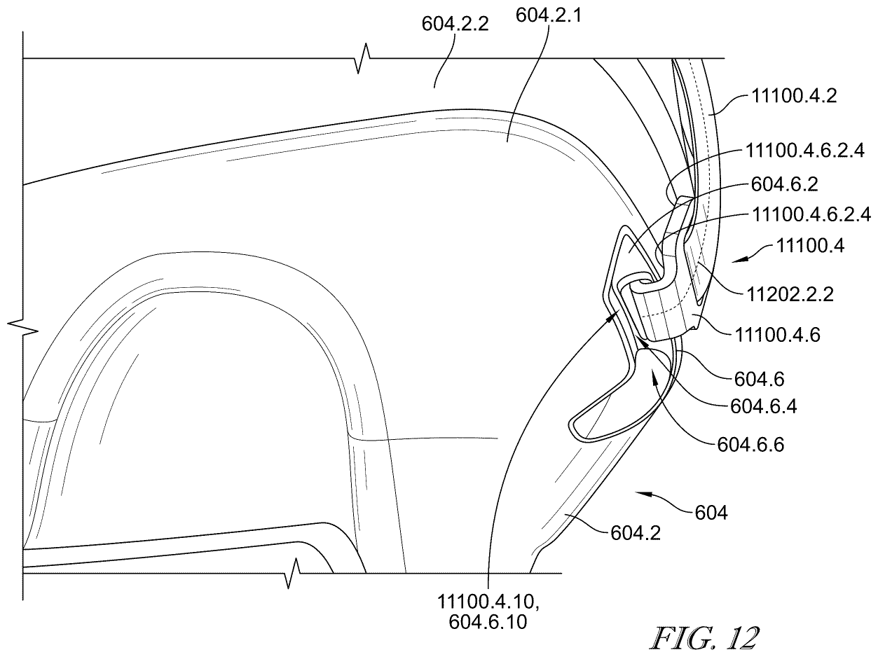

Similar to the overhead support and charging system 10000 as described above, FIGS. 9-12 illustrate an alternative embodiment of an overhead support system 12000 configured to provide tethered charging for the robot 1 through a humanoid robot coupling assembly 11100. This embodiment provides a robust solution for environments or applications where a flexible, vest-like coupling is preferred. For the sake of brevity, the detailed disclosure regarding the shared structural elements and operational modes of the overhead support and charging system 10000 will not be repeated below, but it should be understood that across these embodiments, like reference numbers represent like structures. For example, the disclosure relating to the form and function of the overhead support and charging system 10000 applies with equal force to the overhead support system 12000. Furthermore, it is to be understood that any one or more features of the overhead support and charging system 10000 can be used in conjunction with those disclosed regarding the overhead support system 12000, and vice-versa, creating hybrid implementations.

In general, the overhead support system 12000 differs from the overhead support and charging system 10000 in that the overhead support system 12000 is configured to provide mechanical support and electrical power to the robot 1 through a humanoid robot coupling assembly 11100. The humanoid robot coupling assembly 11100 includes a (i) harness 11100.2, (ii) frame couplers 11100.4, (iii) attachment anchors 11100.2.6.2, and (iv) grab handles 11100.2.10 and 11100.2.12. The overhead support system 12000 includes a tether 12000.2 having at least one electrical conductor 12000.2.2 and a power electronics assembly 12000.3.

a. Harness

The humanoid robot coupling assembly 11100 includes a harness 11100.2 that has a form similar to a vest or shirt, having a chest (e.g., ventral) portion 11100.2.2 configured to be arranged over an upper chest region of the torso 16, and a back (e.g., dorsal) portion 11100.2.4 configured to be arranged over a portion of the upper back region of the torso 16. The chest portion 11100.2.2 and the back portion 11100.2.4 are joined by a pair of shoulder straps 11100.2.6 configured to be arranged over the shoulders 26. Together, the chest portion 11100.2.2, the back portion 11100.2.4, and the shoulder straps 11100.2.6 define a neck opening 11100.2.8 through which the head 10 of the robot 1 can pass during donning.

The harness 11100.2 includes an integrated power bus 11202.2. The power bus 11202.2 includes a pair of electrical conductors 11202.2.2 that electrically connect a corresponding attachment anchor 11100.2.6.2 to a corresponding frame coupler 11100.4 (e.g., the left conductor 11202.2.2 electrically connects the left attachment anchor 11100.2.6.2 to the left frame coupler 11100.4, and the right conductor 11202.2.2 electrically connects the right attachment anchor 11100.2.6.2 to the right frame coupler 11100.4). The electrical conductors 11202.2.2 may be routed within or between the layers of the harness 11100.2 to protect the conductors from external damage and to prevent the conductors from interfering with the movement of the robot 1.

The harness 11100.2 is fabricated from multiple layers of materials having different predetermined textile properties. For example, a compliant, deformable inner layer (e.g., foam, rubber) can be provided to absorb the energy of external impacts and to provide a softer, more flesh-like feel. A soft underlayer (e.g., felt, terry cloth, microfiber cloth) can be provided between the core layer and the torso 16 to prevent the harness 11100.2 from scratching or marring the finish of the torso 16 during use. A tough outer layer (e.g., canvas, woven nylon, rip-stop nylon) can be provided to provide tensile strength across the harness 11100.2 (e.g., to transfer force loads between the shoulder straps 11100.2.6 and the frame couplers 11100.4) and to protect the torso 16 and the harness 11100.2 from cuts, scratches, and point loads (e.g., stabbings). The layers of the harness 11100.2 may be hemmed together at a peripheral edge of the harness 11100.2, and the hem can provide additional mechanical (e.g., tensile loading) strength and prevent separation of the internal layers.

In addition to the above examples, said harness 11100.2 may include any energy absorbing material including: (i) polymers (e.g., polyethylene foam (PE Foam), ethylene vinyl acetate (EVA) foam, polyurethane foam (including Memory Foam and Open-cell Polyurethane Foam), polyimide foam, polyvinyl chloride (PVC) foam, expanded polypropylene (EPP) foam, cross-linked polyethylene foam (XLPE), polyethylene terephthalate (PET) Foam), (ii) rubber foams (e.g., neoprene foam, silicone rubber foam, nitrile butadiene rubber (NBR) foam, ethylene propylene diene monomer (EPDM) foam, vinyl nitrile foam, thermoplastic elastomer (TPE) foam, elastomeric foam), (iii) natural foams, (iv) engineered foams (e.g., microcellular urethane (MCU) foam, reticulated polyurethane foam, melamine foam, convoluted foam), (v) composite and hybrid materials (e.g., multi-layered foams, fiberglass foam composites, metalized foam composites), (vi) expanded polystyrene (EPS), (vii) expanded polypropylene (EPP), (viii) Koroyd®, (ix) D3O®, (x) Poron® XRD, (xi) thermoplastic elastomers (TPE), (xi) thermoplastic polyurethane (TPU), (xii) any other known plastics, (xiii) any combination of the above, and/or (xiv) any other material known to one of skill in the art.

Further, the harness 11100.2 can be made from or include highly durable materials that have high stretch capability and are resistant to pilling, abrasions, and cuts. Said material may include any known material, including but not limited to cotton, polyester, nylon, linen, wool, rayon, modal, viscose, Tencel, elastane (spandex), acrylic, denim, chambray, poplin, tweed, fleece, velvet, canvas, recycled polyester, microfiber, lycra, gabardine, broadcloth, batiste, chiffon, georgette, tulle, mesh fabric, pique knit, interlock knit, rib knit, seersucker, brocade, herringbone weave, jacquard fabric, polyvinyl chloride (PVC), polyurethane (PU), thermoplastic polyurethane (TPU), ethylene vinyl acetate (EVA), polyethylene (PE), polypropylene (PP), low-density polyethylene (LDPE), elastomers, thermoplastic elastomers (TPE), nylon (polyamide), flexible polycarbonate, plasticized PVC, soft silicone, latex, neoprene, synthetic rubber, soft vinyl, flexible acrylic, bioplastics, polyester blends with thermoplastics, fluoropolymers, plastic foams (memory foam blends), polyethylene terephthalate (PET) sheets, thermoplastic polyurethane (TPU) sheets, polypropylene (PP) sheets, polycarbonate sheets, polyvinyl chloride (PVC) sheets, polymethyl methacrylate (acrylic) sheets, high-density polyethylene (HDPE) sheets, fluoropolymer sheets (e.g., PTFE), flexible vinyl sheets, plasticized film sheets, rubberized polymer sheets, ethylene vinyl acetate (EVA) sheets, thermoformed polymer sheets, heat-sealable polymer sheets, antimicrobial polymer sheets, translucent polyethylene sheets, flexible PVC blends, breathable polymer films, coated polymer fabrics, microporous plastic sheets, stretchable polymer films, polyimide sheets, UV-resistant polymer films, electrically conductive polymer sheets, reinforced polymer films, eco-friendly polymer laminates, elastomeric films, neoprene, softshell fabrics, E-PTFE membranes, rubberized fabrics, mesh polymers, plastic-coated textiles, reflective fabrics, phase change materials (PCMS) for thermal regulation, graphene-infused fabrics, smart fabrics with sensors, hydrophobic nanocoated fabrics, Kevlar® reinforced fabrics, carbon fiber-infused textiles, fire-retardant textiles, shape-memory polymers, UV-blocking fabrics, biodegradable plastics for wearable use, conductive fabrics (for wearable electronics), gel-layered fabrics, insulative aerogels, aluminized fabrics, electrospun nanofibers, polylactic acid (PLA) fabrics, self-healing polymers, flexible optical fabrics, fluorescent/glow-in-the-dark polymers, antistatic polymer blends, nanoparticle-infused fabrics, and transparent polymer films for garments. In other words, the use of the term textile here is not simply limited to woven materials.

Additionally, the harness 11100.2 can be customized or selected to reduce wrinkling or the appearance of wrinkling and to allow for twisting or movement of the underlying components without restriction or substantial distortion. An example of a material that may be used includes a 4-way stretch knit textile with a thickness of between 0.1 mm to 10 mm, and preferably between 1.75 mm to about 2.25 mm with a stretch capability between 0% and 100%, and preferably between 25% and 80%. The 4-way stretch characteristic permits the harness 11100.2 to conform to the contours of the torso 16 while accommodating movement of the robot 1 during operation. Further, the harness 11100.2 can include multiple weaves or patterns woven into a custom textile, with or without seams, and adapted to conform with the 3D features of the underlying robot 1. Examples of materials that may be used include repeating patterned elements disposed over a knitted textile or fabric. Said repeating pattern may be located in specific regions (e.g., shoulder, elbow, etc.), while different repeating patterns are used in other locations (e.g., neck, torso, etc.).

Furthermore, this Application contemplates using or including materials in the harness 11100.2 that: (i) integrate lights from the robot 1 into said harness 11100.2, (ii) may be translucent or temporarily translucent (e.g., based on time or environment), or (iii) can be woven in a manner that allows light to transmit through the textile. Specifically, lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser illuminated fiber bunches, phosphor-coated electroluminescent (PCEL) materials, smart RGB led strips, light-up silicone tubing (LED or EL-based), laser wire or other electroluminescent materials (EL wire, EL tape, EL film, etc.)) may be visible through the textile. Said lights may serve functional purposes, such as indicating the charging state of the robot 1, the operating mode of the overhead support system 12000, or the proximity of the robot 1 to obstacles.

Also, the harness 11100.2 may include textiles that include reflective yarn or night luminous yarn that changes appearance when light is shining on the surface. For example, the reflective yarn includes reflective material, which can reflect the light back to the original light source, and provide a better reflective and warning effect. In various embodiments, a shiny, reflective, iridescent, matte, or textured polyurethane film can be applied to the surface of the textile in certain areas for an additional reflective effect or other purpose (e.g., logo, pattern, labels, etc.). Such reflective features may enhance the visibility of the robot 1 in dimly lit or outdoor environments.

Finally, the harness 11100.2 can also include features to accommodate thermal considerations of the robot 1. In various examples, the cover material can be a custom textile, including various weaves within a textile that allow ventilation and have heat sinks built into said textiles. Additionally and/or alternatively, the harness 11100.2 can include textiles or threads that are heat sensitive and change color with a change in temperature. For example, a heat-sensitive material can visually indicate that an underlying component is overheated. Such visual thermal feedback may alert a human operator to a thermal event before the event reaches a threshold that could damage the robot 1 or its surroundings.

In summary, the harness 11100.2 may be made from, include, and specifically omit any one or any combination of the following materials:
Reflective Textiles: retroreflective fabric, high-visibility (hi-vis) fabric, reflective nylon, microprismatic reflective film, Scotchlite™ reflective fabric, aluminum-coated fabric, reflective polyester, glass bead-coated fabric, reflective PVC, reflective tape integrated textiles.
Heat-Sensitive Textiles: thermochromic fabrics, phase-change materials (PCMS), color-changing fabrics (thermal reactive), smart fabrics with embedded sensors, thermo-responsive polymer blends, shape memory alloys integrated fabrics, temperature-regulating fabrics (Outlast®), heat-activated stretch fabrics.
Durable Textiles: Kevlar®, Dyneema®, Cordura®, ballistic nylon, ripstop nylon, heavyweight denim, waxed canvas, teflon-coated fabrics, ultra-high molecular weight polyethylene (UHMWPE), aramid fiber blends, high-tensile polyester, nylon spandex blends, canvas duck cloth.
Illuminant Textiles: fiber optic fabric, electroluminescent (EL) fabric, led-embedded fabric, light-emitting fiber threads, glow-in-the-dark fabric, luminous fabric (photoluminescent), luminescent yarn, solar-powered light-emitting textiles, organic led (OLED) integrated textiles, phosphorescent fabric.
Flame-Resistant Textiles: Nomex®, Carbonx®, Pyrovatex® treated cotton, flame-retardant polyester, modacrylic blends, Indura® cotton, PBI (polybenzimidazole) fabric, Basofil® fabrics, treated wool.
Waterproof Textiles: Gore-Tex®, neoprene, polyurethane-coated fabric, DWR (durable water repellent) treated fabric, PVC-coated polyester, waterproof softshell fabric, TPU (thermoplastic polyurethane) laminated fabric, waterproof canvas.
Hazard Textiles: anti-static fabrics, arc-resistant fabrics, chemical splash protection fabrics, cut-resistant fabrics, flame-resistant hi-vis fabrics, biohazard protection fabrics, impact-resistant fabrics, radiation-protective fabrics, multi-hazard resistant workwear fabrics.
Chemical-Resistant Textiles: Tychem® fabrics, Chemmax® fabrics, polyethylene laminated fabric, butyl-coated fabrics, Viton®-coated fabrics, rubberized protective fabrics, fluoropolymer-coated fabrics.

The harness 11100.2 may incorporate features specifically designed to promote airflow and facilitate heat dissipation away from the robot's torso 16. Specifically, the harness 11100.2 may include highly breathable materials, such as open-weave synthetic mesh textiles (e.g., polyester or nylon mesh with varying aperture sizes), perforated non-woven fabrics, or other materials exhibiting high air permeability and moisture vapor transmission rates. The selection and placement of these breathable panels can be optimized based on known heat concentration zones on the robot's torso 16, thereby maximizing passive heat exchange with the ambient environment. Such breathable panels may be arranged in alternation with structural panels to maintain the tensile strength of the harness 11100.2 while promoting thermal management.

Alternatively and/or additionally, the harness 11100.2 may form a substantial air gap between: (i) the inner surface of the harness 11100.2, and (ii) the torso 16 or a torso cover. Said air gap may be formed between a compressible yet stable open structure that allows air to circulate freely within the gap. Said compressible yet stable open structure may be formed using 3D printed lattice structures, strategically positioned foam standoffs, rubber nodes, or arrangements of resilient monofilament yarns. Also, in certain embodiments, the gap can include channels that are designed to direct airflow, perhaps leveraging natural convection (e.g., with inlets near the bottom edge and outlets near the top) or even aligning with existing vents in the robot's torso 16 to enhance the robot's active thermal management system. Further, the harness 11100.2 may incorporate active cooling elements by including specific pockets or attachment points for receiving thermoelectric cooling modules (Peltier devices) or low-profile fans. These active elements could be powered via a power system that is integrated into the harness 11100.2 and potentially controlled by the robot's thermal management system. Alternatively, the specific pockets or attachment points could be configured to hold encapsulated phase-change materials (PCMs) strategically positioned over heat-prone regions to absorb excess heat during robot operation.

In a further enhancement aimed at optimizing thermal performance, the harness 11100.2 may be configured with an integrated active cooling capability directly embedded within its layered construction. This can be realized through the incorporation of a network of microfluidic channels strategically routed within one or more layers of the harness 11100.2. These channels are designed to circulate a suitable cooling liquid (e.g., water, a dielectric fluid, or a specialized coolant) throughout predetermined regions of the harness, such as areas overlying known heat concentration zones on the robot's torso 16, or potentially distributed across a more substantial portion of the harness assembly for broader thermal management. The microfluidic cooling subsystem can be further provided with inlet and outlet ports configured to interface with an external system that is coupled to the overhead system and/or the robot's 1 primary thermal management system, potentially utilizing compact pumps and heat exchangers resident on the robot 1 or integrated within the harness 11100.2 itself. In embodiments where the tether 12000.2 is configured as a multi-conduit umbilical, the cooling liquid may be supplied to and returned from the harness 11100.2 through fluid conduits within the tether 12000.2.

The harness 11100.2 may further include targeted enhancements that are applied to the harness's 11100.2 internal surface to help prevent scratching or marring of the robot's torso 16 finish. Said enhancements may be applied to the entire internal surface of the harness 11100.2 or may be applied to specific regions by identifying potential high-stress zones through methods such as motion capture analysis of the robot 1 wearing the harness, pressure mapping, or computational simulation of the robot 1 performing its intended tasks. The entire inner surface or specific regions that have been identified via the above analysis could incorporate localized pockets of thicker compliant padding (e.g., gel inserts, viscoelastic foam) for improved pressure distribution and cushioning. Conversely, the entire inner surface or the specific regions could be lined with specialized low-friction materials, such as fabrics coated or woven with polytetrafluoroethylene (PTFE), ultra-high-molecular-weight polyethylene (UHMWPE) fibers, any other known material, and/or any combination thereof

b. Frame Couplers

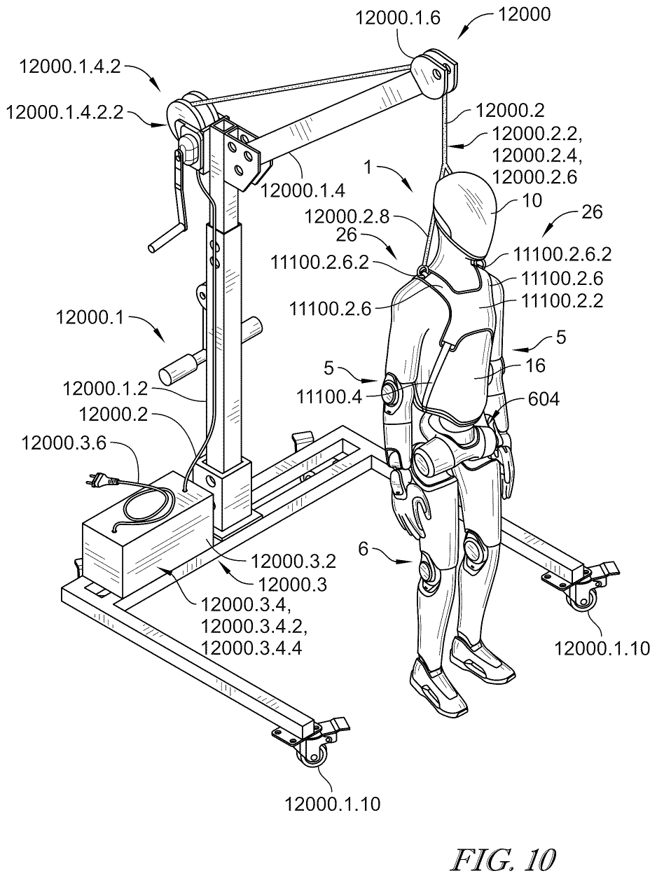

As best shown in FIGS. 9-10, the harness 11100.2 includes a pair of frame couplers 11100.4. The frame couplers 11100.4 each include a waist strap 11100.4.2, a buckle 11100.4.4, a coupler 11100.4.6 (e.g., a hook), and an electrical contact 11100.4.10. Each of the couplers 11100.4.6 includes a main body 11100.4.6.2 defining an aperture 11100.4.6.2.2 and an inner surface 11100.4.6.2.4, a transverse body 11100.4.6.4 defining an inner surface 11100.4.6.4.4, and an angular body 11100.4.6.6 with a projection 11100.4.6.6.2 extending therefrom. The main body 11100.4.6.2, the transverse body 11100.4.6.4, and the angular body 11100.4.6.6 are contiguous portions of the coupler 11100.4.6 that together define a profile shaped to conform to the external geometry of the waist 604 and the harness support 604.6.

A first end 11100.4.2.2 of the waist strap 11100.4.2 is affixed to a lower extent of the front portion 11100.2.2 of the harness, and the waist strap 11100.4.2 passes through the aperture 11100.4.6.2.2 in the coupler 11100.4.6 to the buckle 11100.4.4 located proximal to the second end 11100.4.2.4 of the waist strap. The buckle 11100.4.4 is configured to be positionable along the waist strap 11100.4.2 to provide the harness 11100.2 with an operator-adjustable (e.g., height-wise) fit to the torso 16. The buckle 11100.4.4 is configured to removably couple to a retainer 11100.2.14 that is affixed to a lower extent of the back portion 11100.2.4 of the harness. Together, the buckle 11100.4.4 and the retainer 11100.2.14 are configured as a quick-release coupler assembly. To optimize the transfer of forces and enhance overall structural integrity, the harness 11100.2 may feature explicitly reinforced load paths within its structure. This could involve utilizing continuous loops of high-strength webbing that extend directly from the attachment anchors 11100.2.6.2 and/or grab handles 11100.2.10, 11100.2.12, passing through or being securely layered within the harness structure, and terminating at or integrating directly with the frame couplers 11100.4 or their associated waist straps 11100.4.2. And/or, bar-tack stitching or laminated structural layers could be employed along these defined pathways to ensure efficient force transmission primarily to the robot's waist 604 via the couplers 11100.4.6, thereby minimizing stress on other harness areas or the robot's upper structure. Further, to prevent unintentional release or loosening of the harness, the quick-release buckles 11100.4.4 (and potentially any other buckles disclosed herein) may be replaced or supplemented with locking mechanisms. These modified buckles may include a secondary action to release (e.g., a sliding lock, a double-action release button).

During assembly, the harness 11100.2 can be donned upon the torso 16 of the robot 1 by draping the harness 11100.2 over the torso 16, such that the robot's head 10 passes through the neck opening 11100.2.8 defined between the shoulder straps 11100.2.6, the chest portion 11100.2.2, and the back portion 11100.2.4. The harness 11100.2 is then arranged such that the shoulder straps 11100.2.6 rest upon the shoulders 26, the chest portion 11100.2.2 rests against the upper chest area of the torso 16, and the back portion 11100.2.4 rests against the upper back area of the torso 16, with the waist straps 11100.4.2 hanging along the lateral sides of the torso 16. To facilitate the efficient, accurate, and user-friendly installation and removal (donning and doffing) of the harness 11100.2 onto the humanoid robot 1, visual alignment markings, such as distinct lines, symbols, or color-coded patches, may be applied to both the interior surface of the harness 11100.2 and corresponding reference points on the robot's torso 16 or waist 604. These cues provide clear guidance for operators to correctly position the harness before fastening, ensuring proper alignment of components like shoulder straps 11100.2.6 over shoulders 26 and frame couplers 11100.4.6 relative to their respective recesses 604.6.2. Furthermore, mating components of the fastening system, such as the buckle 11100.4.4 and its corresponding retainer 11100.2.14, or different sections of adjustable straps 11100.4.2, can be color-coded or uniquely labeled to prevent mismatches and streamline the connection process. Further, said harness 11100.2 may incorporate AR-compatible markers or QR codes, allowing operators to rapidly confirm proper harness alignment using augmented reality devices or mobile applications.

To ease the installation of the harness 11100.2, said harness can include a vertical split in its front and back extents that is either centrally formed or asymmetrically formed to generate two halves of the harness 11100.2 that can be coupled to one another using any coupling means including a heavy-duty zipper, quick-release buckles, hook-and-loop fasteners (e.g., Velcro®), or a combination thereof. Or, said harness 11100.2 may include openings formed in the lateral sides of the harness, extending vertically from the lower edge, potentially up to or including the shoulder strap 11100.2.6 area. Further embodiments might feature openings at one or both shoulder straps 11100.2.6, allowing the harness to be opened widely from the top and placed onto the robot's torso 16 without needing to pass over the head 10, before securing the shoulder(s) and waist straps 11100.4.2. In yet another embodiment, the harness 11100.2 may include a wrap-around configuration having a single side opening with an overlap closure, similar to a wrap vest, that permits the harness 11100.2 to be placed on the robot 1 from the front or the rear without passing it over the head 10.

The couplers 11100.4.6 each include an electrical contact 11100.4.10. The electrical contact 11100.4.10 is an electrical conductor that is electrically connected to the conductor 11202.2.2. As will be described in more detail below, the electrical contact 11100.4.10 is configured to conduct charging power from the power bus 11202.2. The couplers 11100.4.6 are engaged with a corresponding harness support 604.6 on the robot's 1 waist 604. The main body 11100.4.6.2, the transverse body 11100.4.6.4, and the angular body 11100.4.6.6 of the coupler 11100.4.6 wrap partly around a lower extent of the torso 16 and the waist 604, such that the inner surface 11100.4.6.2.4 contacts or is adjacent to a waist rim feature, the inner surface 11100.4.6.4.4 contacts or is adjacent to the main body of the waist 604, and the angular body 11100.4.6.6 and the projection 11100.4.6.6.2 extend into the recess 604.6.2 defined in the waist 604.

The harness support 604.6 includes an electrical receptacle 604.6.10. The electrical receptacle 604.6.10 is directly or indirectly electrically connected to the battery 202 located within the torso 16. The electrical receptacle 604.6.10 is configured to be put into electrical communication with the electrical contact 11100.4.10 when the couplers 11100.4.6 are engaged with their corresponding harness support 604.6. As such, a complete electrical circuit is defined between the battery 202 and the power bus 11202.2 when the harness 11100.2 is affixed to the robot 1. In some embodiments, the electrical receptacle 604.6.10 may include spring-loaded contact pins or pogo pins that are biased outward to maintain firm electrical contact with the electrical contact 11100.4.10 as the coupler 11100.4.6 is engaged.

With the couplers 11100.4.6 engaged with the recesses 604.6.2, the buckles 11100.4.4 are coupled to the retainers 11100.2.14 and the strap lengths are adjusted to tension the harness 11100.2 between the shoulder straps 11100.2.6 and the couplers 11100.4.6 and to maintain firm engagement of the couplers 11100.4.6 to the harness supports 604.6. When at least a portion of the weight of the robot 1 is suspended by the harness 11100.2 (at the attachment anchors 11100.2.6.2, the grab handle 11100.2.10, and/or the grab handle 11100.2.12), the suspension forces are transferred from the chest portion 11100.2.2 and/or the back portion 11100.2.4 to the waist straps 11100.4.2, to the couplers 11100.4.6, and ultimately to the structural waist 604 of the robot 1 along the inner surfaces 11100.4.6.2.4 and 11100.4.6.4.4. This force path arrangement allows the robot 1 to be suspended without bearing loads on the shoulder joints or the arm assemblies 5.

To improve the security of the connection between the frame couplers 11100.4.6 and the robot's waist 604, and to further protect the robot's finish, the inner surfaces 11100.4.6.2.4, 11100.4.6.4.4 of the coupler may be augmented in some embodiments. This could involve applying a layer of high-friction, compliant material, such as rubber, silicone, or a specialized polymer coating, to these surfaces. This enhancement increases the frictional grip against the waist 604, reducing potential slippage under load, and provides an additional cushioning layer to prevent scratching or marring of the robot's surface during use. In some embodiments, the high-friction material may be a textured elastomer pad that is bonded or mechanically attached to the inner surfaces 11100.4.6.2.4 and 11100.4.6.4.4.

Additionally and/or alternatively, the harness 11100.2 may incorporate a positive locking mechanism associated with the frame couplers 11100.4.6. While the described engagement geometry between the coupler 11100.4.6, particularly its angular body 11100.4.6.6 and projection 11100.4.6.6.2, and the corresponding recess 604.6.2 in the robot's waist 604 provides primary retention, operational conditions such as significant vibration, dynamic loading, or snagging hazards may create conditions where unintentional disengagement could occur. To mitigate this risk, a positive locking feature can be integrated into the coupler 11100.4.6. Such mechanisms actively prevent disengagement unless deliberately actuated. Examples include, but are not limited to, a spring-loaded pin housed within the coupler body 11100.4.6 configured to automatically engage a corresponding detent within the recess 604.6.2, a manually operated rotating cam lock integrated into the coupler 11100.4.6, or a secondary latch mechanism requiring a distinct manual action to release the coupler.

Alternatively and/or additionally, the harness 11100.2 may be further enhanced with a plurality of adjustment mechanisms beyond the waist buckles 11100.4.4. For instance, the shoulder straps 11100.2.6 may incorporate length adjustment means, such as sliding buckles or hook-and-loop fasteners, allowing modification of the vertical positioning of the harness 11100.2 on the torso 16. Additionally, one or more adjustable straps may span horizontally across the chest portion 11100.2.2 and/or the back portion 11100.2.4, providing means to modify the girth of the harness. Such multi-point adjustability permits a more precise and secure conformation of the harness 11100.2 to varying robot morphologies or when accommodating different underlayers or attached equipment, thereby improving stability and load distribution.

c. Attachment Anchors

The shoulder straps 11100.2.6 each include an attachment anchor 11100.2.6.2 arranged such that the attachment anchors 11100.2.6.2 are positioned over and proximal to an upper extent or peak of the shoulders 26 and are configured to handle both static hanging loads and dynamic fall loads. In the illustrated example, the attachment anchors 11100.2.6.2 are formed as reinforced textile loops that are sewn into or otherwise anchored to the shoulder straps 11100.2.6. Because they are made of a textile material (e.g., high-tensile strength webbing), the attachment anchors 11100.2.6.2 are strong enough to bear the weight of the robot 1 during use, but are also soft enough to not interfere with the movement of the head 10 or cause marring or gouging if they were to come into contact with the head 10 or objects in the robot's environment. However, in some examples, the attachment anchors 11100.2.6.2 can be formed of a rigid material (e.g., a metal D-ring or a molded polymer loop).

The attachment anchors 11100.2.6.2 include at least one electrical contact 11100.2.6.4. The electrical contact 11100.2.6.4 is in electrical communication with a corresponding one of the electrical conductors 11202.2.2. The electrical contact 11100.2.6.4 is also configured to electrically connect to the electrical conductor 12000.2.2 in the tether 12000.2 of the overhead support system 12000. The electrical contact 11100.2.6.4 is configured to form an electrical circuit between the power bus 11202.2 and the tether 12000.2, and by extension, form a part of an electrical pathway from the power electronics assembly 12000.3 to the robot 1.

In use, the attachment anchors 11100.2.6.2 can be used to tether the harness 11100.2 (and the robot 1) to the overhead support system 12000. The attachment anchors 11100.2.6.2 can be affixed by the tether 12000.2 to a cantilever arm, or some other form of overhead gantry, rail, or crane, to help lift and/or support the weight of the robot 1. The connection between the tether 12000.2 and the attachment anchors 11100.2.6.2 may be established via a carabiner, hook, snap-link, or other quick-connect hardware that is selected based upon the anticipated load and the desired speed of connection and disconnection.

When the robot 1 is dressed with the harness 11100.2 and the harness is connected to the tether, at least a portion of the operational power for the robot 1 can be provided by the overhead support system 12000. The electrical contact 11100.2.6.4 is configured to form an electrical circuit between the power bus 11202.2 and the tether 12000.2, and by extension form a part of an electrical pathway from the power electronics assembly 12000.3 to the robot 1 such that the power electronics assembly 12000.3 can provide charging power to the battery 202. As such, the robot 1 can recharge and/or receive supplemental power that can extend its operational runtime (possibly indefinitely) between discreet recharging sessions (e.g., when/where the robot 1 may not be available for its assigned work).

When the robot 1 is dressed with the harness 11100.2 and suspended from the tether, at least a portion of the vertical load of the robot 1 can rest upon and be carried by the couplers 11100.4.6 that are engaged with the recesses 604.6.2, substantially suspending and supporting the robot 1 at the waist 604 and not at the shoulder joints (e.g., the armpits), which might otherwise impede movement of the arm assemblies 5. This waist-based suspension approach distributes the load to the structural waist 604, which is a load-bearing structural member of the robot 1, rather than to articulated joints that could be damaged or constrained by suspension forces.

In some implementations, the operational runtime of the robot 1 between dedicated (e.g., offline) charging sessions can be extended (possibly indefinitely) and/or battery recharging times can be reduced by partly or completely suspending the robot 1 from the overhead support and charging system. For example, by suspending the robot 1, the robot 1 can conserve power that would otherwise be used to operate actuators in the legs 6 in order to keep the robot 1 upright. By reducing the robot's power usage through use of the tether 12000.2, the runtime of the battery 202 can be extended, and/or an increased portion of the power received through the tether 12000.2 can be reallocated to charging the battery 202.

In some embodiments, the attachment anchors 11100.2.6.2 may be configured with an integrated swivel mechanism. This swivel, potentially incorporated at the base where the anchor loop or fixture connects to the shoulder strap 11100.2.6, would allow the anchor point itself to rotate freely (e.g., 360 degrees) relative to the harness 11100.2. Such a feature reduces strain on the tether and harness connection points and can allow for greater freedom of movement for the robot 1 without inducing problematic torque in the suspension system. In some embodiments, the swivel mechanism may include a bearing to reduce rotational friction and a detent or soft stop at a neutral position.

It should be understood that the placement and construction of the attachment anchors 11100.2.6.2 may be designed based upon Finite Element Analysis (FEA) and/or topology optimization analysis of stress distributions under various load conditions (e.g., suspension, lifting, impact). Said analysis may help the harness 11100.2 minimize adverse effects on the robot's balance, agility, gait stability, and actuator workload, while helping ensure that the robot 1 remains upright and centered when it falls and ensuring that said harness 11100.2 has the strength or protective capabilities that are intended for said system. The results of such analysis may inform the selection of materials, the thickness and layering of textile panels, and the placement of reinforcing webbing within the harness 11100.2.

In certain embodiments, the attachment anchors 11100.2.6.2 may be configured with an electromagnetic quick-release mechanism for enhanced operational flexibility and safety. In such configurations, one or more electromagnets are integrated into or positioned adjacent to the attachment anchor points on the harness shoulder straps 11100.2.6 or other designated locations. Correspondingly, the mating component of the overhead system (e.g., the attachment portion previously described, a connecting carabiner, or hook) would incorporate a compatible ferromagnetic element. During normal operation, the electromagnets are energized, generating a strong magnetic field that securely holds the tether's ferromagnetic component, thereby establishing a robust connection capable of supporting operational loads, including the robot's 1 weight. However, for emergency release scenarios (such as entanglement, imminent hazard, or system malfunction), the electrical current supplied to the electromagnets can be intentionally interrupted. This interruption instantly collapses the magnetic field, thereby releasing the tether component from the attachment anchor 11100.2.6.2 with minimal delay or physical force. The control signal to de-energize the electromagnets could be initiated manually by an operator, triggered automatically by the robot's onboard safety systems upon detection of predefined conditions, or activated via a remote command, offering a versatile and rapid means of detachment compared to conventional mechanical latching mechanisms.

d. Grab Handles

The harness 11100.2 includes a rigid grab handle 11100.2.10 and a soft grab handle 11100.2.12 arranged on the back portion 11100.2.4 of the harness. The rigid grab handle 11100.2.10 extends away from the back portion 11100.2.4, and in the illustrated example, the rigid grab handle 11100.2.10 is formed as a bar having a diameter that is appropriate for providing a secure grip to a human operator's hands, or to another robot's hands. The rigid grab handle 11100.2.10 may be fabricated from a metal (e.g., aluminum, steel) or a reinforced polymer, and may include a textured or rubberized grip surface. The soft grab handle 11100.2.12 is formed as a loop of textile (e.g., a padded strap) affixed to the back portion 11100.2.4 and having a diameter that permits a human operator's hand(s) or a robot's hand(s) to reach into the loop and grip the loop.

In some embodiments, the rigid grab handle 11100.2.10 and/or the soft grab handle 11100.2.12 can be directly affixed to structural webbing that is integrated with the frame couplers 11100.4. For example, high-strength waist straps can extend from the couplers 11100.4.6, run between layers of the back portion 11100.2.4 of the harness 11100.2, and integrate with the rigid grab handle 11100.2.10 and/or the soft grab handle 11100.2.12. In such examples, vertical (e.g., lifting) loads on the rigid grab handle 11100.2.10 and/or the soft grab handle 11100.2.12 can be transmitted substantially directly to the frame couplers 11100.4 and thus to the waist 604 of the robot 1.

In use, the rigid grab handle 11100.2.10 and/or the soft grab handle 11100.2.12 can provide locations for a human or another humanoid robot to hold, stabilize, and/or lift the robot 1. For example, if the robot 1 were to fall and require assistance to stand back up, a human or another robot can grasp the rigid grab handle 11100.2.10 and/or the soft grab handle 11100.2.12 to hoist the robot 1 back onto its feet. When the robot 1 is dressed with the harness 11100.2 and lifted by the rigid grab handle 11100.2.10 and/or the soft grab handle 11100.2.12, at least a portion of the vertical load of the robot 1 can rest upon and be carried by the couplers 11100.4.6 that are engaged with the recesses 604.6.2, substantially suspending and supporting the robot 1 at the waist 604 and not at the shoulder joints (e.g., the armpits), which might otherwise impede movement of the arm assemblies 5.

In some embodiments, the rigid grab handle 11100.2.10 and/or the soft grab handle 11100.2.12 can be affixed to a rigid support base plate layered within the back portion 11100.2.4 and configured to distribute mechanical loads placed upon the handles across a wider surface area of the harness 11100.2 and/or to improve force transfer between the rigid grab handle 11100.2.10 and the shoulder straps 11100.2.6 and/or the couplers 11100.4.6. This may be beneficial because said humanoid robot coupling assembly 11100 may be coupled to the robot 1 while said robot 1 is not on an overhead support system, and the humanoid robot coupling assembly 11100 may provide extra support and protection to the robot 1 if it happens to fall. For example, said rigid grab handle 11100.2.10 may help distribute impact forces away from a sensitive area, such as an upper edge of the battery pack 202, if the robot 1 falls backward while not connected to an overhead support system. The rigid support base plate may be fabricated from a lightweight material (e.g., a carbon fiber composite or an aluminum alloy) to minimize the added mass while providing sufficient stiffness for load distribution.

In some embodiments, the rigid grab handle 11100.2.10 and/or the soft grab handle 11100.2.12 can be configured to be suspended from other supports. In some embodiments, the humanoid robot coupling assembly 11100 can be configured with other types of grips or mount points (e.g., hook-and-loop fastener pads, magnets, Modular Lightweight Load-carrying Equipment (MOLLE) loops, DIN rails). For example, the rigid grab handle 11100.2.10, the soft grab handle 11100.2.12, or other mounting points can be configured to attach to an overhead tether or support system. In some embodiments, the harness can be configured to support or carry additional equipment or accessories. For example, the rigid grab handle 11100.2.10, the soft grab handle 11100.2.12, or other mounting points can be configured to carry tools for use by the robot 1 (e.g., a form of tool belt for factory environments). In another example, the humanoid robot coupling assembly 11100 can be configured to carry a backpack or other form of container or luggage, robotic peripherals, external mechanical equipment, and/or electronic equipment. For example, the humanoid robot coupling assembly 11100 can be configured to help the robot 1 carry hard drives or other data storage devices, specialized sensors, additional cameras, long-range communications equipment, positioning equipment (e.g., GPS), an external battery, portable power generation equipment (e.g., a fuel cell), cable reels/spools, a winch, medical equipment, protective gear (e.g., armor, heat shielding, radiation shielding), fire suppression equipment (e.g., a fire extinguisher), a parachute, a flotation device, auxiliary lights, speakers, a public address system, or combinations of these and/or any other appropriate payload that can be carried by the robot 1. In further embodiments, the humanoid robot coupling assembly 11100 may include integrated low-profile storage compartments or zippered pockets in accessible locations.

To address the need for routing wires associated with harness-mounted peripherals or robot sensors, the harness may incorporate dedicated cable management features. These could comprise fabric tunnels, elasticated loops sewn onto the harness surface, zippered channels running along strap edges or panels, or rigid conduits integrated within the harness layers. Such features allow for the organized and secure routing of cables, minimizing the risk of snagging on external objects, protecting cables from damage, and maintaining a cleaner, more professional appearance of the equipped robot 1.

Additionally and/or alternatively, the humanoid robot coupling assembly 11100 may integrate standardized interfaces for the attachment of auxiliary equipment. For example, the humanoid robot coupling assembly 11100 may include rigid polymer or metal plates with predefined mounting patterns (e.g., VESA-like patterns, grid patterns) affixed onto the back portion 11100.2.4 or other suitable areas. Alternatively, standardized rail systems, such as Picatinny rails (MIL-STD-1913) or DIN rails, could be affixed to or integrated within the harness structure. These standardized systems allow for the rapid, secure, and interchangeable mounting of a wide variety of off-the-shelf or custom tools, sensors, batteries, or other modules, significantly enhancing the mission adaptability of the robot 1. In some embodiments, the standardized interfaces may include electrical pass-through connectors that allow auxiliary equipment to draw power from the integrated power bus 11202.2 and/or from the overhead support system 12000 via the tether 12000.2.

### G. Alternative Embodiments

In various embodiments, the rigid braces and frame couplers may be fabricated from advanced materials to reduce mass and improve performance without compromising strength. One such embodiment utilizes lightweight alloys, including but not limited to, Titanium alloys such as Ti-6Al-4V for its high strength-to-weight ratio, Aluminum-Lithium alloys for their superior stiffness, or Magnesium alloys for applications where minimal weight is the primary design consideration. The surface of these components may be treated with a hard-anodized or ceramic-converted coating for corrosion and abrasion resistance. Another embodiment employs a hybrid composite laminate, such as carbon-fiber reinforced Polyether Ether Ketone (PEEK), which may incorporate an embedded metal mesh layer that serves as both a structural element and a pathway for electrical conductivity and EMI shielding, protecting sensitive onboard electronics from interference. To provide superior electrical insulation and wear resistance, the braces may be coated using a plasma electrolytic oxidation (PEO) process, which electrochemically grows a dense, hard ceramic layer on the component surface, offering higher dielectric strength than conventional polymer coatings. Such constructions reduce the overall mass and inertia of the coupling assembly while maintaining sufficient structural strength for operational loads.

In another set of embodiments, the tether's construction is modified to enhance its electrical and mechanical properties. The mechanically tensionable member may be fabricated from a high-strength, non-conductive fiber, such as Ultra-High-Molecular-Weight Polyethylene (UHMWPE) or a Liquid Crystal Polymer (LCP), with electrical conductors co-extruded within a single protective outer jacket. For data transmission, the tether may be configured with one or more optical fibers to provide high-bandwidth, noise-free communication that is immune to electromagnetic interference from sources such as high-power motor drivers or external industrial equipment. To achieve complete electrical isolation, which is advantageous in high-voltage or potentially explosive environments, this data link may be implemented using a Power-over-Fiber (PoF) system. In such a system, a laser transmits optical power through the fiber to a photovoltaic receiver on the robot, which converts the light into electrical energy for powering communication circuits, resulting in a fully dielectric connection to the robot.

To improve the reliability and service life of the rotatable electrical interface 10000.1.4.2.2, the winch assembly may incorporate a contactless rotary transformer housed within the winch drum, in place of a conventional slip-ring assembly. This configuration utilizes inductive coupling to transfer energy, thereby eliminating mechanical wear, friction, particulate generation, and the potential for contamination associated with brush-based electrical contacts, rendering it suitable for cleanroom or sensitive environments. In a further embodiment, the humanoid robot coupling assembly may be secured to the robot using alternative fastening mechanisms, such as electromagnetic clasps or mechanical ratcheting straps, in place of retaining pins and buckles. Such mechanisms are configured to permit rapid, tool-less, and potentially automated attachment and detachment of the coupling assembly, thereby improving the efficiency of equipping or reconfiguring the robot for different tasks.

In various embodiments, the overhead system may be configured to actively track and position the robot within its workspace. One such embodiment provides for an active XY overhead trolley configured to move along a ceiling-mounted rail system, operatively coupled to a positioning system utilizing Ultra-Wideband (UWB) or LiDAR beacons. A closed-loop control system uses this positional data to automatically track the robot, maintaining a minimal tether swing angle and reducing dynamic loads. Another embodiment replaces the tether and winch with an articulated arm, such as a serial or parallelogram linkage arm, configured to precisely position the attachment point over the robot within a defined volumetric workspace, which is advantageous in cluttered environments. For applications requiring movement along an extended linear path, such as an assembly line, the overhead system may comprise a conductor bar or busway track with a sliding current collector, providing continuous and uninterrupted power and support. These configurations maintain a proper orientation of the support connection, minimizing lateral forces and trip hazards.

The point of attachment to the robot and the management of forces may also be varied to optimize stability and safety. A tri-point suspension system may be used, wherein a third attachment point on a dorsal spine region of the robot creates a stable load triangle that aligns forces with the robot's center of mass. Alternatively, a dorsal spine rail, analogous to a backpack frame, may be used to centralize support and fall-arrest loads along the primary vertical structural frame, reducing stress on appendages. To decouple the robot's rotational motion from the tether and prevent tether winding, a floating gimbal with three degrees of freedom may be incorporated at the attachment point. Furthermore, a sacrificial, inline energy-absorbing link, such as a tear-webbing strap or a crush-tube element, may be disposed in the tether to dissipate kinetic energy and limit the peak shock load during a fall-arrest event. To manage the physical behavior of the tether, a constant-force spring balancer may be integrated in-line with the winch to prevent slack loops, and the tether may be configured as a segmented, semi-rigid boom tether to maintain clearance from the robot's head-mounted sensors.

Various embodiments are contemplated to manage the flow of electrical power and enhance energy efficiency. A supercapacitor module, which has a higher power density than conventional batteries, may be integrated into the base to absorb and discharge transient energy from brief, high-power events like regenerative braking. This may be combined with a bidirectional DC-to-DC converter to enable regenerative backfeed capture, allowing energy from the robot to be stored at the base. Furthermore, the control system may employ dynamic power scheduling, shifting between an “assist” mode during high-load activities and a “charge” mode during idle periods. For high-energy tasks, a protocol may be implemented to bypass the robot's battery and directly power the main bus, which reduces cycling on the main battery, extends its service life, and allows for tasks whose power draw would exceed the battery's own discharge rating.

The electrical connection sequence and system control can be enhanced for safety and longevity. The system may execute a pre-charge and soft-connect sequence, using a secondary circuit with inrush current control to mitigate electrical arcing that can cause pitting and degradation of the power contacts. The winch control system may also be integrated with the robot's navigation AI to preemptively adjust tether length based on the robot's intended path, preventing the tether from becoming taut or slack unexpectedly. For system maintenance, a service mode may utilize a low-voltage bus to power essential diagnostic systems while high-power systems are safely isolated in compliance with lockout-tagout procedures. The data connection may also be used for field-reconfigurable firmware updates using an A/B partitioning scheme to provide a fail-safe update mechanism. In another embodiment, the system may transfer power wirelessly via a directed microwave or laser beam, wherein a rectenna array on the robot converts the beamed energy into usable power, and the tether provides only mechanical support.

In various embodiments, the overhead support system may be deeply integrated with facility infrastructure. The power electronics may be configured to integrate with a building's DC microgrid or an uninterruptible power supply (UPS) to ensure continuous operation and enable load-shifting of charging operations. The tether system may also be integrated with a facility's safety interlock system, such as a Programmable Logic Controller (PLC), to trigger an emergency stop of nearby machinery if a fall is detected. In another embodiment, the overhead system may be integrated with building infrastructure, such as a fire suppression system, allowing the robot to be suspended over a hazardous environment while receiving fire-retardant agents through a specialized conduit. Such facility-level integration enables the overhead support system to function as part of a broader automated safety and operations framework within the workspace.

The tether may be configured as a multi-conduit umbilical to deliver co-routed utilities in addition to power and data. Such utilities may include, but are not limited to, compressed air for pneumatic grippers, vacuum lines, or liquid coolant for active thermal management of the robot's systems. The high-bandwidth data link provided by the tether may be utilized for shared computation, wherein computationally intensive tasks, such as processing high-resolution sensor data for environmental mapping or running large-scale simulations, are offloaded from the robot's onboard processors to a more powerful computer in the overhead system. This enables the robot to execute more complex AI and analysis tasks than would be possible with its own computational resources alone. The offloading of computation may be managed by the compute module 1000 of the robot 1 and the central computer 10000.3.4.4, which may negotiate task allocation based on available bandwidth and processing demand.

### H. Industrial Application

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US26/13952, PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, and 19/252,708; and (iii) U.S. Design patent application Ser. Nos. 29/889,764, 29/928,748, 29/935,680, 29/954,572, 29/967,462, 29/993,115, and 29/998,761; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this Application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. An overhead support and charging system for a humanoid robot, comprising:
a base including a vertical arm supporting a horizontal cantilever arm;
a tether extending from the base and including at least one electrical conductor and at least one mechanically tensionable cable;
a power electronics assembly configured to convert utility power into charging power suitable for the humanoid robot; and
a coupler at a distal end of the tether configured to mechanically and electrically connect the tether to a humanoid robot coupling assembly.

2. The overhead support and charging system of claim 1, wherein the horizontal cantilever arm includes a pulley at a distal end configured to guide the tether.

3. The overhead support and charging system of claim 2, further comprising a winch assembly configured to extend, retract, and hold the tether at set extensile positions.

4. The overhead support and charging system of claim 3, wherein the winch assembly includes a rotatable electrical interface configured to maintain electrical conductivity while the winch assembly rotates during operation of the tether.

5. The overhead support and charging system of claim 1, wherein the power electronics assembly comprises: a shell configured as a mechanically protective and electrically insulating housing; electronic subsystems housed within the shell and including power conversion electronics and a central computer; and a power cord extending from the power electronics assembly and configured to receive power from a standard wall outlet.

6. The overhead support and charging system of claim 1, wherein the tether further includes one or more communication conductors configured to provide a communication bus selected from CAT5/6/7 Ethernet, USB, I2C, CAN, or MODBUS for data transmission between the overhead support and charging system and the humanoid robot.

7. A humanoid robot coupling assembly for connecting a humanoid robot to an overhead support and charging system, comprising:
a pair of frame couplers configured to be coupled to an upper extent of a torso of the humanoid robot;
a pair of rigid braces, each rigid brace coupled to a corresponding frame coupler and hinged together at respective first ends; and
wherein the rigid braces are electrically insulated from each other and are configured to conduct electrical power from the overhead support and charging system to the humanoid robot.

8. The humanoid robot coupling assembly of claim 7, wherein each rigid brace comprises: a hinged portion located at the first end; a first transition portion extending outward from the hinged portion; a vertical portion; a second transition portion extending inward from the vertical portion; and an attachment portion located at a second end and configured to couple to the corresponding frame coupler.

9. The humanoid robot coupling assembly of claim 7, wherein the rigid braces are covered by an electrically insulating cover to prevent accidental electrical contact, the electrically insulating cover comprising a polymer selected from rubber, plastic, or a ceramic coating.

10. The humanoid robot coupling assembly of claim 7, wherein the frame couplers are configured to provide both mechanical contact and electrical continuity with the rigid braces through direct metal-on-metal contact, and wherein the frame couplers are fabricated from a high-strength material selected from steel or a reinforced composite.

11. A harness for a humanoid robot, comprising: a chest portion configured to be arranged over an upper chest region of a torso of the humanoid robot; a back portion configured to be arranged over an upper back region of the torso; a pair of shoulder straps joining the chest portion and the back portion; a pair of frame couplers each including a waist strap and a coupler configured to engage with a harness support on a waist of the humanoid robot; and an integrated power bus including electrical conductors connecting attachment anchors on the shoulder straps to the frame couplers.

12. The harness of claim 11, wherein each coupler comprises: a main body defining an aperture and an inner surface; a transverse body defining an inner surface; and an angular body with a projection extending therefrom and configured to extend into a recess defined in the waist of the humanoid robot.

13. The harness of claim 12, wherein each frame coupler further comprises a buckle configured to be positionable along the waist strap to provide an operator-adjustable fit to the torso, and wherein the buckle is configured to removably couple to a retainer affixed to the back portion of the harness such that the buckle and retainer together form a quick-release coupler assembly.

14. The harness of claim 11, wherein the attachment anchors each include at least one electrical contact in electrical communication with a corresponding electrical conductor, and wherein the electrical contact is configured to electrically connect to an electrical conductor in a tether of an overhead support system.

15. A humanoid robot configured for use with an overhead support and charging system, comprising:
a torso assembly extending vertically between a waist and a head and neck assembly; an electronics assembly housed within the torso assembly and including a battery pack and a power distribution unit;
a pair of frame couplers positioned at an upper extent of the torso assembly and electrically connected to the battery pack via conductors; and
wherein the frame couplers are configured to mechanically and electrically couple to a humanoid robot coupling assembly.

16. The humanoid robot of claim 15, wherein the torso assembly has a total internal volume of more than 15 liters and less than 40 liters, and wherein the battery pack has an energy capacity exceeding 2.5 kWh.

17. The humanoid robot of claim 16, wherein the torso assembly has an uninterrupted internal height of more than 250 mm and less than 350 mm, and wherein the battery pack provides an operational runtime of over 3.5 hours under normal operating conditions.

18. The humanoid robot of claim 15, wherein each frame coupler provides a structural loop configured to be removably connected to rigid braces via retaining pins, and wherein each frame coupler is in electrical communication with the battery pack through a corresponding conductor of a power bus.

19. A tether system for connecting a humanoid robot to an overhead support and charging system, comprising: at least one electrical conductor configured to transmit charging power; at least one mechanically tensionable cable configured to provide mechanical support for the humanoid robot; an electrical insulator covering the electrical conductor; a coupler at a distal end configured to mechanically and electrically connect to a humanoid robot coupling assembly; and wherein the tether is configured to be extended and retracted by a winch assembly.

20. The tether system of claim 19, wherein the mechanically tensionable cable comprises a material selected from rope, strap, wire, cordage, chain, webbing, or braided strands of elongated material, and wherein the coupler includes a quick-attach mechanism configured to establish both mechanical support and electrical connectivity through a single unified coupler mechanism.
